(19) United States
(12) Patent Application Publication
(10) Pub. No.: US 2008/0218135 A1
(43) Pub. Date: Sep. 11, 2008

(54) Voltage Supplying Device and an Image Display Device

(75) Inventor: Hajime Nagai, Tokyo (JP)

Correspondence Address: LIU & LIU, 444 S. FLOWER STREET, SUITE 1750, LOS ANGELES, CA, 90071, US

(73) Assignee: TPO Hong Kong Holding Limited

(21) Appl. No.: 10/589,686

(22) PCT Filed: Feb. 18, 2005
(86) PCT No.: PCT/IB2005/050608

§ 371 Date: May 20, 2008

(30) Foreign Application Priority Data
Feb. 19, 2004 (JP) 2004-043187

(51) Int. Cl. G05F 1/00

(52) U.S. Cl. 323/265

(57) ABSTRACT

To provide a voltage supplying device and an image display device, which can bring a voltage on a line to be supplied with voltage (e.g. source line) to a substantially desired voltage. A voltage supplying device comprising a source line (L12), a source line (L13) adjacent to the source line (L12), and a voltage generating means for generating a voltage supplied to the source line (L12) and a voltage supplied to the source line (L13), wherein the voltage generating means receives a pixel data (D12) representing a driving voltage (v12) for on the source line (L12) and a pixel data (D13) representing a driving voltage (v13) for on the source line (L13), and generates a correction voltage (v12-Δv3) different from the driving voltage (v12) using the received pixel data (D12) and (D13), and wherein the voltage supplying device supplies the source line (L12) with the correction voltage (v12-Δv3).

### TECHNICAL FIELD

The present invention relates to a voltage supplying device comprising a first line, a second line adjacent to said first line and a voltage generating means for generating a voltage supplied to said first line and a voltage supplied to said first line.

The present invention further relates to an image display device comprising such voltage supplying device.

### BACKGROUND ART

A TFT having low temperature polycrystalline silicon (LTPS) makes it possible in a practical level to provide, on a glass substrate, means for sequentially connecting a plurality of source lines to a common video line. The supply of voltage from the common video line to a plurality of source lines offers an advantage in that more miniaturization of mobile devices (e.g. mobile phone) become possible.

### DISCLOSURE OF INVENTION

### Technical—Problem

However, while the plurality of source lines are sequentially connected to the common video line, a voltage on the source line may deviate through the crosstalk between the adjacent source lines. In this case, although the source line is supplied with a desired voltage, such voltage deviation causes the deviation of the voltage on the source line from a desired voltage, so that an image degradation may arise.

A object of the present invention is to provide a voltage supplying device and an image display device in which a voltage on a line (e.g. source line) supplied with a voltage can substantially become a desired voltage.

### Technical—Solution

A voltage supplying device according to the present invention for achieving the object described above comprising a first line, a second line adjacent to said first line, and a voltage generating means for generating a voltage supplied to said first line and a voltage supplied to said first line, wherein said voltage generating means receives a first data representing a first voltage for said first line and a second data representing a second voltage for said second line, and generates a correction voltage different from said first voltage using said received first and second data, and wherein said voltage supplying device supplies said first line with said correction voltage.

The present invention dose not supply the first line with the first voltage itself represented by the first data, but generates a correction voltage using the first and second data and supplies the first line with the correction voltage. To supply the first line with such correction voltage makes it possible that the voltage on the first line substantially becomes the desired voltage.

In the voltage supplying device according to the present invention, said voltage generating means may comprise a first correction means for generating a correction data representing said correction voltage using said first and second data and a first converting means for converting said correction data into said correction voltage. In this case, said first correction means may determine an amount of correction in data of said first data using said second data, and generates said correction data by correcting said first data using said amount of correction in data.

In the voltage supplying device according to the present invention, said device may comprise a third line adjacent to said first line, said second and third lines being on the opposite sides of the said first line, and wherein said voltage generating means may receive also a third data representing a third voltage for said third line, and generate said correction voltage using said received first, second and third data.

If the first line is adjacent to the third line in addition to the second line, to generate the correction voltage using also the third data makes it possible to obtain more suitable correction voltage. In this case, said correction data representing the correction voltage may be generated using said first, second and third data, and an amount of correction in data of said first data may be determined using said second and third data.

In the voltage supplying device according to the present invention, said voltage generating means may comprise a second converting means for converting said first data into said first voltage and converting said second data into said second voltage and a second correction means for generating said correction voltage using said first and second voltages. In this case, said second correction means may generate said correction voltage by correcting said first voltage using said second voltage.

In the voltage supplying device according to the present invention, said device may comprise a third line adjacent to said first line, said third line existing opposite said second line, wherein said voltage generating means may receive a third data for said third line, wherein said second converting means may convert said received third data into said third voltage, and wherein said second correction means may generate said correction voltage using said first, second and third voltages.

If the first line is adjacent to the third line in addition to the second line, to produce the correction voltage using even the third data makes it possible to obtain more suitable correction voltage. In this case, said second correction means may generate said correction voltage by correcting the first voltage using said second and third voltage.

### DESCRIPTION OF DRAWINGS

FIG. 1 is a schematic view showing an image display device 1 of a first embodiment according to the present invention.

FIG. 2 is a schematic diagram showing the image display device 101 which dose not correct the image signal Sp.

FIG. 3 shows a timing chart of the image display device 101 shown in FIG. 2.

FIG. 4 shows the signal processing part 8.

FIG. 5 is illustration of determining the amount of deviation in voltage caused through the crosstalk.

FIG. 6 schematically illustrates waveform of the voltages V13(t), V21(t), V22(t), V23(t) on the source lines L13, L21, L22, L23.

FIG. 7 illustrates one example of ways in which the correcting part 7 corrects the pixel data D11 and D12 on the basis of the above equations (3′) and (1′).

FIG. 8 illustrates one example of ways in which the correcting part 7 corrects the pixel data D21 and D22 on the basis of the above equations (8′) and (6′).

FIG. 9 is a variation of the correcting part 7.

FIG. 10 shows an image display device 11 of a second embodiment according to the present invention.

FIG. 11 is a circuit diagram showing the correcting part A1.

FIG. 12 shows voltages inputted into the input portions In1 and In2 of the correcting part A1 and a voltage outputted from an output portion Out of the correcting part A1.

FIG. 13 is a circuit diagram showing the correcting part A2.

FIG. 14 shows voltages inputted into the input portions In1, In2 and In3 of the correcting part A2 and a voltage outputted from an output portion Out of the correcting part A2.

FIG. 15 shows an image display device 12 of the third embodiment according to the present invention.

FIG. 16 is a schematic diagram showing the image display device 102 which dose not correct the image signal Sp.

FIG. 17 shows a timing chart of the image display device 102 shown in FIG. 16.

FIG. 18 shows one example of the signal processing part 80.

FIG. 19 is illustration of determining the amount of deviation in voltage caused through the crosstalk.

FIG. 20 is illustration of explaining how to correct the pixel data D13.

FIG. 21 shows an image display device 13 of the fourth embodiment according to the present invention.

FIG. 22 shows voltages inputted into the input portions In1 and In2 of the correcting part 42 and a voltage outputted from an output portion Out of the correcting part 42.

### BEST MODE

The present invention will be described using an image display device, but it is noted that the present invention can be applied to the other device than the image display device.

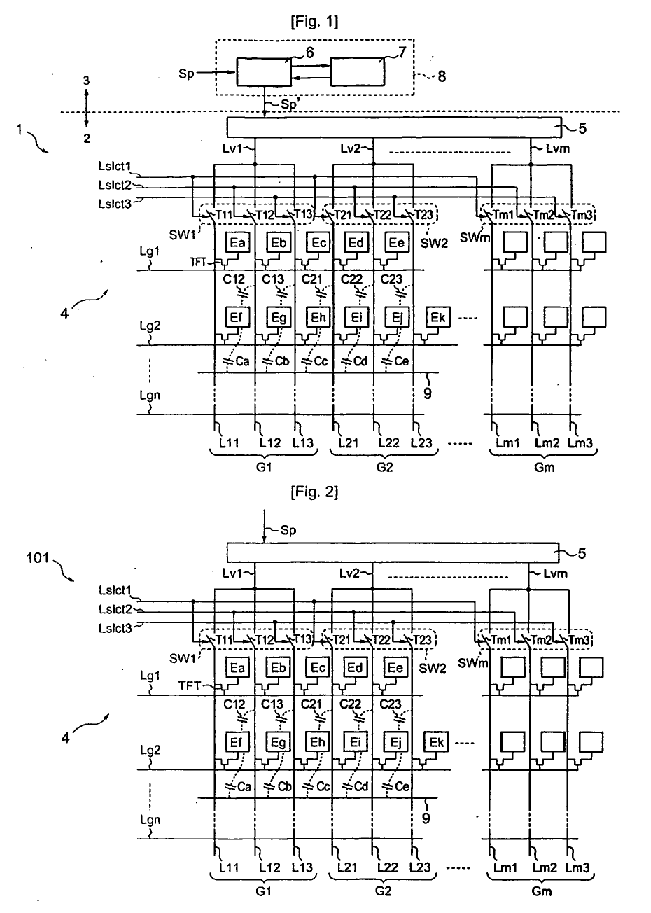

FIG. 1 is a schematic view showing an image display device 1 of a first embodiment according to the present invention.

In FIG. 1, parts of the image display device 1 at the sides of a glass substrate 2 and a printed circuit board 3 are schematically shown. At the side of the glass substrate 2, provided are an electronic circuit part 4, three selecting lines Lslct1, Lslct2, and Lslct3, m video lines Lv1, Lv2, . . . , Lvm, a source driver 5 and others. At the side of the printed circuit board 3, provided are a signal processing part 8 and others. The electronic circuit part 4 on the glass substrate 2 comprises pixel electrodes Ea, Eb, . . . arranged in matrix pattern. Further, n gate lines Lg1, Lg2, . . . , Lgn and m source line groups G1, G2, . . . , Gm are extended among the pixel electrodes Ea, Eb, . . . E each of m source line groups consists of three source lines. The source line group G1 consists of three source lines L11, L12, and L13. Similarly, the source line group G2 consists of three source lines L21, L22, and L23, and the source line group Gm consists of three source lines Lm1, Lm2, and Lm3. The electronic circuit part 4 comprises TFTs. Each of TFTs corresponds to a respective one of the pixel electrodes Ea, Eb, . . . . These TFTs are turned on and off depending on voltages supplied from the gate lines Lg1, Lg2, . . . , and Lgn. Voltages from the source lines are supplied to the pixel electrodes through TFTs in on state. On the glass substrate 2, m video lines Lv1, Lv2, . . . , Lvm are formed. Each of m video lines Lv1, Lv2, . . . , Lvm corresponds to a respective one of m source line groups G1, G2, . . . , Gm. Since one source line group comprises three source lines, one video line is provided so as to correspond to three source lines. Switch groups SW1, SW2, . . . , SWm are provided between the video lines Lv1, Lv2, . . . , Lvm and the source line groups G1, G2, . . . , Gm, respectively. Each of the switch groups consists of three transistors. The switch group SW1 consists of three transistors (e.g. Thin Film Transistor) T11, T12, and T13. Similarly, the switch group SW2 consists of three transistors T21, T22, and T23 and the switch group SWm consists of three transistors Tm1, Tm2, and Tm3. The transistors T11, T21, . . . , Tm1 are turned on and off depending on voltages supplied from the selecting line Lslct1. Similarly, the transistors T12, T22, . . . , Tm2 are turned on and off depending on voltages supplied from the selecting line Lslct2, and the transistors T13, T23, . . . , Tm3 are turned on and off depending on voltages supplied from the selecting line Lslct3. The video line Lv1 is electrically connected to each of the source lines L11, L12, and L13 when a respective one of the transistors T11, T12, and T13 is in on state and is electrically disconnected from each of the source lines L11, L12, and L13 when a respective one of the transistors T11, T12, and T13 is in off state. Ditto for the other video lines Lv2, . . . , Lvm.

The signal processing part 8 provided on the print circuit board 3 receives an image signal Sp having a number of pixel data and then corrects the received image signal Sp in order to prevent or reduce the image degradation caused through the crosstalk between the adjacent source lines. The corrected image signal Sp′ is outputted in to the source driver 5. The source driver 5 supplies each of the video lines Lv1, Lv2, . . . , Lvm with a voltage on the basis of the corrected image signal Sp′. The voltages supplied to the video lines Lv1, Lv2, . . . , Lvm are supplied to pixels through the source lines.

It is noted that, as described above, the signal processing part 8 corrects the received image signal Sp in order to prevent or reduce the image degradation caused through the crosstalk between the adjacent source lines. In the image display device 1 shown in FIG. 1, the source driver 5 outputs the voltage into each of the video lines Lv1 to Lvm on the basis of the corrected image signal Sp′, so the image degradation caused through the crosstalk between the adjacent source lines is prevented or reduced. In contrast, assuming that the image display device 1 dose not correct the image signal Sp and thus supplies the image signal Sp itself to the source driver 5, the image degradation would occur through the crosstalk between the adjacent source lines. In order to consider the reason for an occurrence of the image degradation, we discuss below an operation of an image display device which dose not correct the image signal Sp.

FIG. 2 is a schematic diagram showing the image display device 101 which dose not correct the image signal Sp.

The image display device 101 shown in FIG. 2 is the same as the image display device 1 shown in FIG. 1, except that the image signal Sp is not corrected and thus the image signal Sp itself is supplied to the source driver 5.

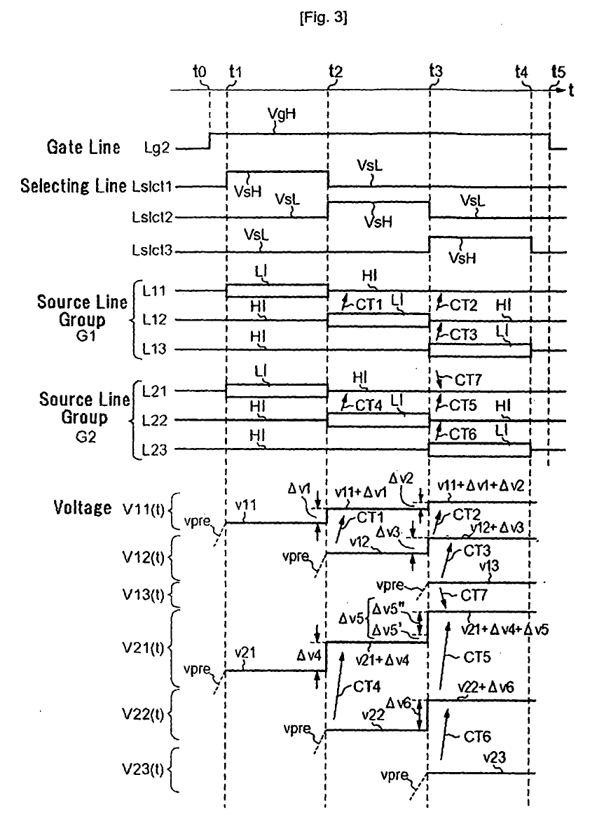

FIG. 3 shows a timing chart of the image display device 101 shown in FIG. 2.

FIG. 3 shows a timing chat while a gate line Lg2 of n gate lines of the image display device 101 is supplied with a high level voltage VgH. Three selecting lines Lslct1, Lslct2, and Lslct3 are supplied with a high level voltage VsH and a low level voltage VsL while the gate line Lg2 is supplied with the high level voltage VgH. The selecting line Lslct1 is supplied with the high level voltage VsH during a period from an instant t1 to an instant t2, the selecting line Lslct2 is supplied with the high level voltage VsH during a period from the instant t2 to an instant t3, and the selecting line Lslct3 is supplied with the high level voltage VsH during a period from the instant t3 to an instant t4. In this way, the selecting lines Lslct1, Lslct2, and Lslct3 are sequentially supplied with the high level voltage VsH. The voltage VsH makes transistors of each of the switch groups SW1 to SWm to on-state and the voltage VsL makes transistors of each of the switch groups SW1 to SWm to off-state. Therefore, for example, three transistors T11, T12, and T13 of the switch group SW1 become on-state in this order. The three transistors of each of the other switch groups SW2 to SWm become on-state in this order. Therefore, when the voltage on the selecting line Lslct1 is the high level voltage VsH (the instants t1 to t2), each of the source lines L11, L21, . . . , Lm1 is being connected to a respective one of the video lines, in other words, is in “low-impedance state L1” (“low-impedance state L1” means that a source line is being connected to a video line corresponding to this source line. Ditto for the following), but the remaining source lines are being disconnected from the video lines, in other words, are in “high-impedance state HI” (“high-impedance state HI” means that a source line is being disconnected from a video line corresponding to this source line. Ditto for the following). When the voltage on the selecting line Lslct2 is the high level voltage VsH (the instants t2 to t3), the source lines L12, L22, . . . , Lm2 are in the low-impedance state L1, but the remaining source lines are in the high-impedance state HI. When the voltage on the selecting line Lslct3 is the high level voltage VsH (the instants t3 to t4), the source lines L13, L23, . . . , Lm3 are in the low-impedance state L1, but the remaining source lines are in the high-impedance state HI. FIG. 3 illustrates the changes of the states of two source line groups G1 and G2 adjacent to each other (i.e. six source lines L11 to L23) as an example. The image display device 101 supplies any source line groups G1 to Gm with the voltages in a similar manner, so it is explained below, as an example, how two source line groups G1 and G2 are supplied with the voltages.

The source driver 5 simultaneously supplies the source lines with pre-charge voltages vpre in advance. The pre-charge voltage vpre is zero voltage in this example, but may take any value. After the source lines are supplied with the pre-charge voltages vpre (zero voltage), the source lines L11 and L21 first become the low-impedance state L1 (the instants t1 to t2). Further, the source driver 5 receives pixel data D11 representing the driving voltage v11 and pixel data D21 representing the driving voltage v21, converts each of the received pixel data D11 and D21 into a respective one of the driving voltages v11 and v21 (DA conversion), and then outputs each of the driving voltages v11 and v21 into a respective one of the video lines Lv1 and Lv2. The driving voltages v11 and v21 are voltages to be supplied to the pixel electrodes Ef and Ei through the source lines L11 and L21, respectively. Since the source lines L11 and L21 are in the low-impedance state L1 in a period from the instant t1 to the instant t2, the driving voltages v11 and v21 are supplied to the source lines L11 and L21, respectively. Therefore, a voltage V11(t) on the source line L11 changes from the pre-charge voltage vpre to the driving voltage v11 at the instant t1, on the other hand, a voltage V21(t) on the source line L21 changes from the pre-charge voltage vpre to the driving voltage v21 at the instant t1.

Next, the source lines L12 and L22 become the low-impedance state LI (the instants t2 to t3). On the other hand, the source driver 5 receives pixel data D12 rep-resenting driving voltage v12 and pixel data D22 representing driving voltage v22, converts each of the received pixel data D12 and D22 into a respective one of the driving voltages v12 and v22 (DA conversion), and then outputs each of the driving voltages v12 and v22 into a respective one of the video lines Lv1 and Lv2. The driving voltages v12 and v22 are voltages to be supplied to the pixel electrodes Eg and Ej through the source lines L12 and L22, respectively. Since the source lines L12 and L22 are in the low-impedance state L1 in a period from the instant t2 to the instant t3, the driving voltages v12 and v22 are supplied to the source lines L12 and L22, respectively. Therefore, a voltage V12(t) on the source line L12 changes from the pre-charge voltage vpre to the driving voltage v12 at the instant t2, on the other hand, a voltage V22(t) on the source line L22 changes from the pre-charge voltage vpre to the driving voltage v22 at the instant t2.

Next, the source lines L13 and L23 become the low-impedance state L1 (the instants t3 to t4). On the other hand, the source driver 5 receives pixel data D13 rep-resenting driving voltage v13 and pixel data D23 representing driving voltage v23, converts each of the received pixel data D13 and D23 into a respective one of the driving voltages v13 and v23 (DA conversion), and then outputs each of the driving voltages v13 and v23 into a respective one of the video lines Lv1 and Lv2. The driving voltages v13 and v23 are voltages to be supplied to the pixel electrodes Eh and Ek through the source lines L13 and L23, respectively. Since the source lines L13 and L23 are in the low-impedance state L1 in a period from the instant t3 to the instant t4, the driving voltages v13 and v23 are supplied to the source lines L13 and L23, respectively. Therefore, a voltage V13(t) on the source line L13 changes from the pre-charge voltage vpre to the driving voltage v13 at the instant t3, on the other hand, a voltage V23(t) on the source line L23 changes from the pre-charge voltage vpre to the driving voltage v23 at the instant t3.

As described above, each source lines is supplied with the voltage. Hereinafter, we discuss the voltage V11(t) on the source line L11 and the voltage V12(t) on the source line L12, the lines L11 and L12 belonging to the source line group G1.

The source driver 5 supplies the source line L11 with the driving voltage v11 through the video line Lv1 during the period from the instant t1 to the instant t2, so that the voltage V11(t) on the source line L11 becomes v11(V11(t)=v11). Next, the source driver 5 outputs the driving voltage v12 into the video line Lv1 during the period from the instant t2 to the instant t3 in order to supply the source line L12 with the driving voltage v12. Since the source line L12 changes from the high-impedance state HI to the low-impedance state L1 at the instant t2, the driving voltage v12 is supplied to the source line L12 and thus the voltage V12(t) on the source line L12 becomes v12 (V12(t)=v12). It is required that the driving voltage v12 is not supplied to the source line L11 since the driving voltage v12 is the voltage for use on the source line L12. For this purpose, the source line L11 changes from the low-impedance state L1 to the high-impedance state HI at the instant t2. Therefore, the driving voltage v12 is prevented from being supplied to the source line L11. It is however noted that during the period from the instant t2 to the instant t3 the source line L12 is in the low-impedance state L1, but the source line L11 is in the high-impedance state HI. This means that the source line L11 is electrically disconnected from the video line Lv1, and thus the supply of the voltage from the video line Lv1 to the source line L11 is being blocked. Therefore, the voltage V11(t) on the source line L11 varies through a crosstalk CT1 between the source lines L11 and L12. Since the voltage V12(t) on the source line L12 changes from the pre-charge voltage vpre (voltage zero) to the driving voltage v12 at the instant t2, the voltage V12(t) changes by an amount of change in voltage, i.e. v12 (=v12−vpre) at the instant t2. Therefore, the voltage V11(t) on the source line L11 deviates by an amount of deviation in voltage Δv1 at the instant t2, the amount Δv1 depending on the amount of change in voltage (i.e. v12) on the source line L12.

Therefore, the voltage V11(t) on the source line L11 is the desired driving voltage v11 at first, but is affected by the change of voltage on the source line L12 through the crosstalk CT1 and thus deviates from the voltage v11 to a voltage v11+Δv1.

Further, the source driver 5 outputs the driving voltage v13 into the video line Lv1 during the period from the instant t3 to the instant t4 in order to supply the source line L13 with the driving voltage v13. Since the source line L13 changes from the high-impedance state HI to the low-impedance state L1 at the instant t3, the driving voltage v13 is supplied to the source line L13 and thus the voltage V13(t) on the source line L13 becomes v13 (V13(t)=v13). It is required that the driving voltage v13 is not supplied to the source line L12 since the driving voltage v13 is the voltage for use on the source line L13. For this purpose, the source line L12 changes from the low-impedance state L1 to the high-impedance state HI at the instant t3. Therefore, the driving voltage v13 is prevented from being supplied to the source line L12. It is however noted that during the period from the instant t3 to the instant t4 the source line L13 is in the low-impedance state L1, but the source line L12 is in the high-impedance state HI. This means that the source line L12 is electrically disconnected from the video line Lv1, and thus the supply of the voltage from the video line Lv1 to the source line L12 is being blocked. Therefore, the voltage V12(t) on the source line L12 varies through a crosstalk CT3 between the source lines L12 and L13. Since the voltage V13(t) on the source line L13 changes from the pre-charge voltage vpre (voltage zero) to the driving voltage v13 at the instant t3, the voltage V13(t) changes by an amount of change in voltage, i.e. v13 (=v13−vpre) at the instant t3. Therefore, the voltage V12(t) of the source line L12 deviates through the crosstalk CT3 by an amount of deviation in voltage Δv3 at the instant t3, the amount Δv3 depending on the amount of change in voltage (i.e. v13) on the source line L13.

Therefore, the voltage V12(t) on the source line L12 is the desired driving voltage v12 at first, but is affected by the change of voltage on the source line L13 through the crosstalk CT3 and thus deviates from the voltage v12 to a voltage v12+Δv3. As a result, the voltage V12(t) on the source line L12 deviates from the desired driving voltage v12 by the amount of deviation in voltage Δv3, so that the image is degraded.

Further, since the voltage V12(t) on the source line L12 deviates by the amount of deviation in voltage Δv3, the voltage V11(t) on the source line L11 is affected by the amount of deviation in voltage Δv3 through the crosstalk CT2 and thus deviates by an amount of deviation in voltage Δv2. As a result, on the source line L11, there are the deviation in voltage Δv1 through the crosstalk CT1 and the deviation in voltage Δv2 through the crosstalk CT2.

Next, we discuss the voltage V21(t) on the source line L21 and the voltage V22(t) on the source line L22, the lines L21 and L22 belonging to the source line group G2.

The voltages V21(t) and V22(t) on the source lines L21 and L22 can be explained similarly to the voltages V11(t) and V12(t) on the source lines L11 and L12. The voltage V21(t) on the source line L21 is the desired driving voltage v21 at first, but deviates by an amount of deviation in voltage Δv4 through a crosstalk CT4 between the source lines L21 and L22. On the other hand, the voltage V22(t) on the source line L22 is the driving voltage v22 at first, but deviates by an amount of deviation in voltage Δv6 through a crosstalk CT6 between the source lines L22 and L23 at the instant t3. Further, the voltage V21(t) on the source line L21 deviates at the instant t3 through a crosstalk CT5 between the source lines L21 and L22. It is noted that the source line L21 is adjacent to not only the source line L22 but also the source line L13. Therefore, the voltage V21(t) on the source line L21 deviates at the instant t3 through a crosstalk CT7 between the source lines L13 and L21. That is, the voltage V21(t) on the source line L21 is affected by the deviation of the voltage on the source line L22 through the crosstalk CT5 and further affected by the change of the voltage on the source line L13 through the crosstalk CT7. Specifically, the voltage V21(t) on the source line L21 deviates by an amount of deviation in voltage Δv5′ through the crosstalk CT5 and deviates by an amount of deviation in voltage Δv5″ through the crosstalk CT7. As a result, the voltage V21(t) on the source line L21 deviates by an amount of deviation in voltage Δv5 (=Δv5′+Δv5″) at the instant t3.

Therefore, the voltage V21(t) on the source line L21 is the driving voltage v21 at first, but becomes the voltage v21+Δv4+Δv5. As a result, the voltage V21(t) on the source line L21 deviates from the desired driving voltage v21 by the amount of deviation in voltage Δv4+Δv5, so that the image is degraded.

The above description is given to the case in which the voltage on the source line deviates upwardly through the crosstalk, and a below description will be given to the case in which the voltage on the source line deviates upwardly through the crosstalk. It is however noted that a voltage on one source line may deviate downwardly through the crosstalk, depending on e.g. a magnitude relationship between a pre-charge voltage and a driving voltage (the pre-charge voltage and the driving voltage both being for use on the source line adjacent to said one source line).

The source line groups G3 to Gm also undergo the similar deviation in voltage as the source line group G2.

As described above, in the image display device 101, the voltage on the source line deviates through the crosstalk, so that image is degraded. In contrast, the image display device 1 (see FIG. 1) according to the present invention makes use of such deviation in voltage on the source line in order to prevent the image degradation. Specifically, the image display device 1 predicts an amount of deviation in voltage on a source line and then supplies the source line with a correction voltage, the correction voltage differing by the predicted amount of deviation in voltage from an original voltage expected to be supplied to the source line. The supply of the correction voltage to the source line makes it possible to prevent the image from degrading. It will be described below how to generate such correction voltage.

The image display device 1 shown in FIG. 1 comprises a memory 6 and a correcting part 7 in the signal processing part 8 in order to generate such correction voltage.

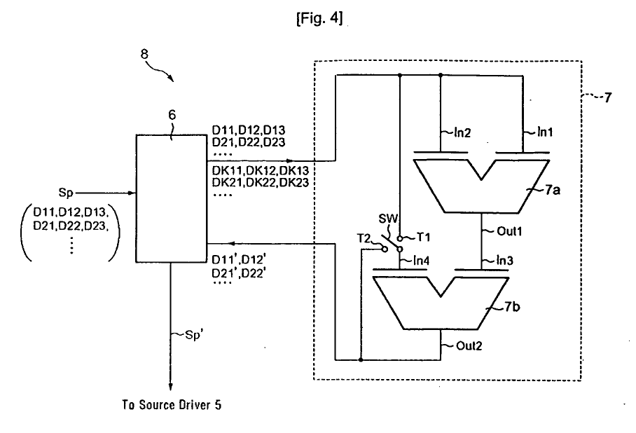

FIG. 4 shows the signal processing part 8.

The signal processing part 8 comprises the memory 6 and the correcting part 7. The memory 6 stores each pixel data of the image signal Sp temporarily. The correcting part 7 corrects the temporarily stored pixel data in consideration of an amount of deviation in voltage caused through the crosstalk and then outputs such corrected pixel data into the memory 6. The memory 6 stores the corrected pixel data. After the memory 6 stores the corrected pixel data in this way, an image signal Sp′having the corrected pixel data is read out from the memory 6 and is supplied to the source driver 5 (see FIG. 1). The source driver 5 supplies a source line with a voltage through a video line on the basis of such image signal Sp′. Therefore, the source driver 5 supplies the source line with a voltage differing from the desired voltage by the amount of deviation in voltage caused through the crosstalk, but the voltage on the source line deviates through the crosstalk and thus finally substantially becomes the desired voltage. It is however noted that, in order for the voltage on the source line to substantially become the desired voltage, the correcting part 7 is required to correct the pixel data by an amount of correction corresponding to the amount of deviation in voltage caused through the crosstalk. If the amount of correction in pixel data is largely different from the amount of deviation in voltage caused through the crosstalk, the voltage on the source line having deviated through the crosstalk can not substantially become the desired voltage. To circumvent such case, the correcting part 7 determines the amount of deviation in voltage caused through the crosstalk as follows.

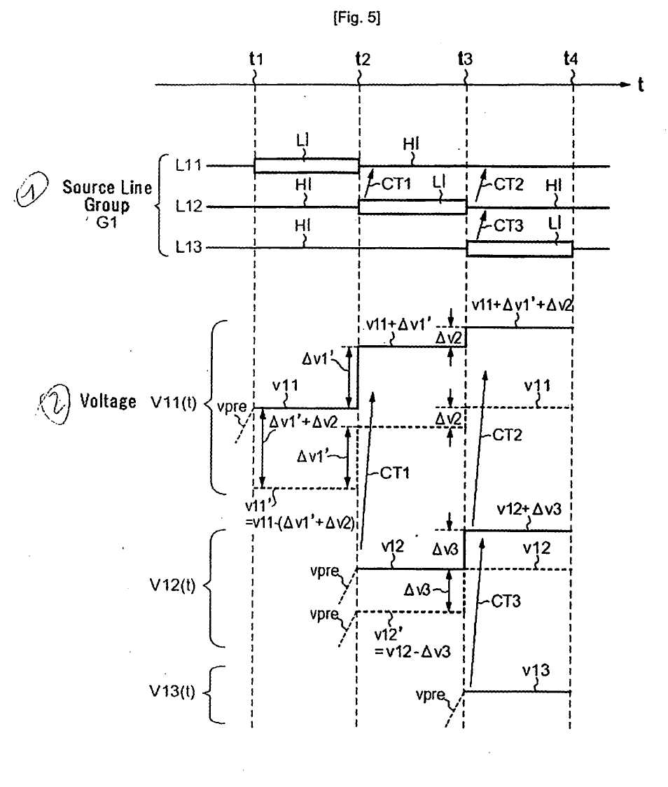

FIG. 5 is illustration of determining the amount of deviation in voltage caused through the crosstalk.

FIG. 5 schematically illustrates waveforms of the voltages V11(t), V12(t), V13(t) on the source lines L11, L12, L13. At first, we discuss the voltage V12(t) on the source line L12. If the source line L12 is supplied with the driving voltage v12, the voltage V12(t) on the source line L12 deviates from the driving voltage v12 to a voltage v12+Δv3 through a crosstalk CT3 between the source lines L12 and L13. Therefore, if the source line L12 is supplied with a correction voltage v12′ represented by an equation (1) below instead of the driving voltage v12, the voltage V12(t) on the source line L12 can finally become the desired driving voltage v12.

v12′=v12−Δv3 (1)

The correction voltage v12′ is obtained by correcting the driving voltage v12 by the amount of deviation in voltage Δv3 used as the correction amount. If the correction voltage v12′ is supplied to the source line L12, the voltage V12(t) on the source line L12 is first smaller than the desired driving voltage v12 by Δv3, but deviates through the crosstalk CT3 and thus finally reaches the desired driving voltage v12.

It is noted that the amount of deviation in voltage Δv3 is substantially determined on the basis of the amount of change in voltage (v13=v13−vpre) of the voltage V13(t) on the source line L13 at the instant t3, a parasitic capacitance C13 and a liquid crystal capacitance Cb (see FIG. 1). The parasitic capacitance C13 is formed between the source line L13 and the pixel electrode Eg, and the liquid crystal capacitance Cb is formed between the common electrode 9 and the pixel electrode Eg. The values of the parasitic capacitance C13 and the liquid crystal capacitance Cb both can be known from kinds of the liquid crystal material, source line material and others, and can be considered as substantially constant values. Therefore, the amount of deviation in voltage Δv3 can be calculated using an equation (2) below.

Δv3=K13×v13 (2)

Where, a coefficient K13 is a constant value substantially determined on the basis of the parasitic capacitance C13 and the liquid crystal capacitance Cb. Since the correction voltage v12′ can be calculated using the equations (1) and (2), the source line L12 can be supplied with the correction voltage v12′.

Next, we discuss the voltage V11(t) on the source line L11.

If the source line L11 is supplied with the driving voltage v11, the voltage V11(t) on the source line L11 deviates from the driving voltage v11 through a crosstalk CT1 between the source lines L11 and L12. See FIG. 3, FIG. 3 illustrates that the voltage V11(t) deviates from v11 by an amount of deviation in voltage Δv1 through the crosstalk CT1, but it is noted that the amount of deviation in voltage Δv1 varies depending on a value of voltage supplied to the source line L12 at the instant t2. The amount of deviation in voltage Δv1 practically shown in FIG. 3 is an amount obtained by supplying the source line L12 with the driving voltage v12 at instant t2. If the source line L12 is supplied with the correction voltage v12′ obtained by the equations (1) and (2) instead of the driving voltage v12, the voltage V11(t) on the source line L11 deviates, as shown in FIG. 5, from v11 by an amount of deviation in voltage Δv1′ through the crosstalk CT1.

Further, the voltage V11(t) on the source line L11 deviates through the crosstalk CT2 at instant t3. It is noted that, as shown in FIG. 5, the voltage V12(t) on the source line L12 deviates by the amount of deviation in voltage Δv3 at instant t3 even if the source line L12 is supplied with either the driving voltage v12 or the correction voltage v12′. Therefore, even if the source line L12 is supplied with the correction voltage v12′, the voltage V11(t) on the source line L11 deviates by Δv2 through the crosstalk CT2 similarly to the voltage V11(t) shown in FIG. 3. Finally, the voltage V11(t) on the source line L11 deviates from the driving voltage v11 to a voltage v11+Δv1′+Δv2. Therefore, if the source line L11 is supplied with a correction voltage v11′ represented by an equation (3) below instead of the driving voltage v11, the voltage V11(t) on the source line L11 can finally become the desired driving voltage v11.

v11′=v11−(Δv1′+Δv2) (3)

The correction voltage v11′ is obtained by correcting the driving voltage v11 by a sum of the amounts of deviation in voltage Δv1′ and Δv2 used as the correction amount. If the correction voltage v11′ is supplied to the source line L11, the voltage V11(t) on the source line L11 is first smaller than the desired driving voltage v11 by Δv1′+Δv2, but deviates (by Δv1′ and Δv2) through the crosstalks CT1 and CT2, and thus finally reaches the desired driving voltage v11.

The amount of deviation in voltage Δv1′ is substantially determined on the basis of the amount of change in voltage (v12′=v12′−vpre) of the voltage V12(t) on the source line L12 at the instant t2, a parasitic capacitance C12 and a liquid crystal capacitance Ca (see FIG. 1). On the other hand, the amount of deviation in voltage Δv2 is substantially determined on the basis of the amount of deviation in voltage Δv3 of the voltage V12(t) on the source line L12 at the instant t3, the parasitic capacitance C12 and the liquid crystal capacitance Ca (see FIG. 1). The parasitic capacitance C12 is formed between the source line L12 and the pixel electrode Ef, and the liquid crystal capacitance Ca is formed between the common electrode 9 and the pixel electrode Ef. Therefore, the amounts of deviation in voltage Δv1′ and Δv2 can be calculated using equations (4) and (5) below, respectively.

Δv1′=K12×v12′=K12×(v12−Δv3) (4)

Δv2=K12×v3 (5)

Where, a coefficient K12 is a constant value substantially determined on the basis of the parasitic capacitance C12 and the liquid crystal capacitance Ca. Since the correction voltage v11′ can be calculated using the equations (3), (4) and (5), the source line L11 can be supplied with the correction voltage v11′.

It is noted that since the voltage V13(t) on the source line L13 has no deviation caused through crosstalk, the source line L13 need not be supplied with a correction voltage and thus can be supplied with the driving voltage v13 itself.

Therefore, when the source line group G1 is supplied with the voltages, the source line L13 need not be supplied with a correction voltage but the source lines L11 and L12 need to be supplied with the correction voltages.

From the consideration described above, it is understood that to supply the source line L11 with the correction voltage v11′ and to supply the source line L12 with the correction voltage v12′ are good.

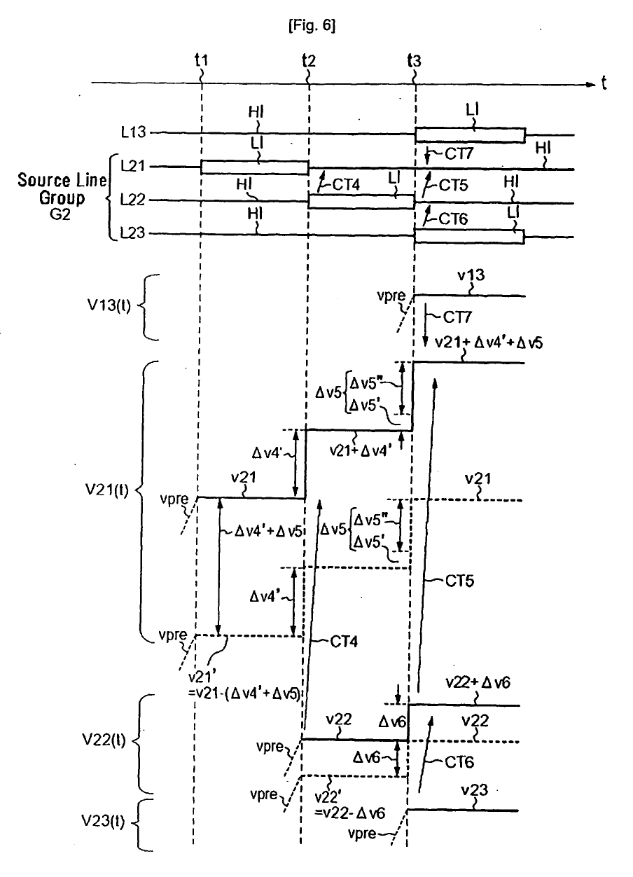

Next, correction voltages supplied to the source line group G2 will be explained with reference to FIG. 6.

FIG. 6 schematically illustrates waveform of the voltages V13(t), V21(t), V22(t), V23(t) on the source lines L13, L21, L22, L23. At first, we discuss the voltage V22(t) on the source line L22. The voltage V22(t) can be considered similarly to the voltage V12(t) on the source line L12 shown in FIG. 5. That is, the voltage V22(t) deviates from the driving voltage v22 by an amount of deviation in voltage Δv6 through a crosstalk CT6 between the source lines L22 and L23 and thus deviates from the driving voltage v22 to a voltage v22+Δv6. Therefore, Therefore, if the source line L22 is supplied with a correction voltage v22′ represented by an equation (6) below instead of the driving voltage v22, the voltage V22(t) on the source line L22 can finally become the desired driving voltage v22.

v22′=v22−Δv6 (6)

The correction voltage v22′ is obtained by correcting the driving voltage v22 by the amount of deviation in voltage Δv6 used as the correction amount. If the correction voltage v22′ is supplied to the source line L22, the voltage V22(t) on the source line L22 is first smaller than the desired driving voltage v22 by Δv6, but deviates through the crosstalk CT6 and thus finally reaches the desired driving voltage v22. Since the voltage V22(t) on the source line L22 increases by the amount of deviation in voltage Δv6 through the crosstalk CT6 as shown in FIG. 6, the correction voltage v22′ is defined so as to be smaller than the driving voltage v22 by the amount of deviation in voltage Δv6 as represented in the equation (6). However, if the voltage V22(t) on the source line L22 decreases by the amount of deviation in voltage Δv6 through the crosstalk CT6, the correction voltage v22′ may be defined so as to be larger than the driving voltage v22 by the amount of deviation in voltage Δv6.

It is noted that the amount of deviation in voltage Δv6 is substantially determined on the basis of the amount of change in voltage (v23=v23−vpre) of the voltage V23(t) on the source line L23, a parasitic capacitance C23 and a liquid crystal capacitance Ce (see FIG. 1). The parasitic capacitance C23 is formed between the source line L23 and the pixel electrode Ej, and the liquid crystal capacitance Ce is formed between the common electrode 9 and the pixel electrode Ej. Therefore, the amount of deviation in voltage Δv6 can be calculated using an equation (7) below.

Δv6=K23×v23 (7)

Where, a coefficient K23 is a constant value substantially determined on the basis of the parasitic capacitance C23 and the liquid crystal capacitance Ce. Since the correction voltage v22′ can be calculated using the equations (6) and (7), the source line L22 can be supplied with the correction voltage v22′.

Next, we discuss the voltage V21(t) on the source line L21. If the source line L21 is supplied with the driving voltage v21, the voltage V21(t) on the source line L21 deviates from the driving voltage v21 through a crosstalk CT4 between the source lines L21 and L22. See FIG. 3, FIG. 3 illustrates that the voltage V21(t) deviates from v11 by an amount of deviation in voltage Δv4 through a crosstalk CT4, but it is noted that the amount of deviation in voltage Δv4 varies depending on a value of voltage supplied to the source line L22 at the instant t2. The amount of deviation in voltage Δv4 practically shown in FIG. 3 is an amount obtained by supplying the source line L22 with the driving voltage v22 at instant t2. If the source line L22 is supplied with the correction voltage v22′ obtained by the equations (6) and (7) instead of the driving voltage v22, the voltage V21(t) on the source line L21 deviates, as shown in FIG. 6, from v21 by an amount of deviation in voltage Δv4′ through the crosstalk CT4.

Further, the voltage V21(t) on the source line L21 deviates through the crosstalks CT5 and CT7 at instant t3. It is noted that, as shown in FIG. 6, the voltage V22(t) on the source line L22 deviates by an amount of deviation in voltage Δv6 at instant t3 even if the source line L22 is supplied with either the driving voltage v22 or the correction voltage v22′. Therefore, even if the source line L22 is supplied with the correction voltage v22′, the voltage V21(t) on the source line L21 deviates by Δv5′ through the crosstalk CT5 similarly to the voltage V21(t) shown in FIG. 3. Further, since the source line L13 is supplied with the driving voltage v13 itself, the voltage V21(t) on the source line L21 deviates by Δv5″ through the crosstalk CT7 similarly to the voltage V21(t) shown in FIG. 3. Finally, the voltage V21(t) on the source line L21 deviates from the driving voltage v21 to a voltage v21+Δv4′+Δv5. Therefore, if the source line L21 is supplied with a correction voltage v21′ represented by an equation (8) below instead of the driving voltage v21, the voltage V21(t) on the source line L21 can finally become the desired driving voltage v21.

v21′=v21−(Δv4′+Δv5) (8)

The correction voltage v21′ is obtained by correcting the driving voltage v21 by a sum of the amounts of deviation in voltage Δv4′ and Δv5 used as the correction amount. If the correction voltage v21 is supplied to the source line L21, the voltage V21(t) on the source line L21 is first smaller than the desired driving voltage v21 by Δv4′+Δv5, but deviates (by Δv4′ and Δv5) through the crosstalks CT4,CT5 and CT7, and thus finally reaches the desired driving voltage v21.

The amount of deviation in voltage Δv4′ is substantially determined on the basis of the amount of change in voltage (v22′=v22′−vpre) of the voltage V22(t) on the source line L22 at the instant t2, a parasitic capacitance C22 and a liquid crystal capacitance Cd (see FIG. 1). The amount of deviation in voltage Δv5′ is substantially determined on the basis of the amount of deviation in voltage Δv6 of the voltage V22(t) on the source line L22 at the instant t3, the parasitic capacitance C22 and the liquid crystal capacitance Cd (see FIG. 1). Further, the amount of deviation in voltage Δv5″ is substantially determined on the basis of the amount of change in voltage (v13) of the voltage V13(t) on the source line L13 at the instant t3, a parasitic capacitance C21 and a liquid crystal capacitance Cc (see FIG. 1). The parasitic capacitance C21 is formed between the source line L21 and the pixel electrode Eh, the parasitic capacitance C22 is formed between the source line L22 and the pixel electrode Ei, and the liquid crystal capacitance Cc is formed between the common electrode 9 and the pixel electrode Eh. Therefore, the amounts of deviation in voltage Δv4′, Δv5′ and Δv5″ can be calculated using equations (9), (10) and (11) below, respectively.

Δv4′=K22×v22′=K22×(v22−Δv6) (9)

Δv5′=K22×Δv6 (10)

Δv5′=K21×v13 (11)

Where, a coefficient K21 is a constant value substantially determined on the basis of the parasitic capacitance C21 and the liquid crystal capacitance Cc, and a coefficient K22 is a constant value substantially determined on the basis of the parasitic capacitance C22 and the liquid crystal capacitance Cd. Since the correction voltage v21′ can be calculated using the equations (8) to (11), the source line L21 can be supplied with the correction voltage v21′.

It is noted that since the voltage V23(t) on the source line L23 has no deviation caused through crosstalk, the source line L23 need not be supplied with a correction voltage and thus can be supplied with the driving voltage v23 itself.

Correction voltages for use on the other source line groups G3 to Gm also can be determined similarly to the correction voltages for use on the source line group G2.

In order to determine such correction voltages, the image display device 1 shown in FIG. 1 comprises a multiplier 7a and a subtractor 7b in the correcting part 7. The multiplier 7a calculates an amount of deviation in voltage caused through crosstalk. The subtractor 7b corrects the image data using the amount of deviation in voltage calculated by the multiplier 7a. It is described below in detail how the correcting part 7 corrects the pixel data.

As shown in FIG. 4, the pixel data D11, D12, . . . of the image signal Sp are once written in the memory 6. The signal processing part 8 corrects the written pixel data with its correcting part 7 before the signal processing part 8 outputs the written pixel data into the source driver 5. The correcting part 7 corrects the pixel data for the purpose of supplying the correction voltages mentioned with respect to FIGS. 5 and 6 to the source lines. For example, the correcting part 7 corrects the pixel data D12 having been stored in the memory 6 to a pixel data D12′, the pixel data D12 representing the driving voltage v12 and the pixel data D12′ representing the correction voltage v12′ (see equation (1)). The correction voltage v12′ can be calculated by substituting the equation (2) into the equation (1). This calculation equation is represented by an equation (1′) below.

v12′=v12−(K13×v13) (1′)

Further, the correcting part 7 corrects the pixel data D11 having been stored in the memory 6 to a pixel data D11′, the pixel data D11 representing the driving voltage v11 and the pixel data D1′ representing the correction voltage v11′(see equation (3)). The correction voltage v11′ is calculated using the equation (3), and the second and third terms Δv1′ and Δv2 in the right side of the equation (3) are represented by the equations (4) and (5), respectively. Therefore, the correction voltage v11′ can be determined by calculating the equations (4) and (5) and then substituting the calculation results into the equation (3). The correction voltage v11′ may be determined in this way, but can be more easily calculated without calculating the equations (4) and (5). In order to calculate the correction voltage v11′ more easily, we try to substitute the equations (4) and (5) into the equation (3).

v11′=v11−(Δv1′+Δv2) (3)

=v11−(K12×(v12−Δv3)+K12×Δv3) (see the equations (4) and (5))

=v11−(K12×v12) (3′)

Since the correction voltage v11′ is simply represented by the equation (3′), the correction voltage v11′ can be determined by calculating (K12×v12) as the correction amount and then substituting the calculated (K12×v12) into the equation (3′) without calculating the equations (4) and (5).

In order to correct the pixel data D11 and D12 using the above equations (3′) and (1′), respectively, the correcting part 7 operates as follows.

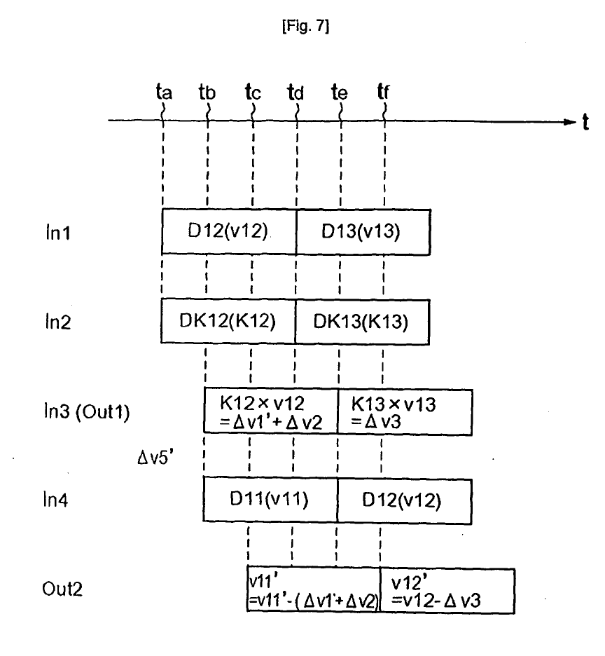

FIG. 7 illustrates one example of ways in which the correcting part 7 corrects the pixel data D11 and D12 on the basis of the above equations (3′) and (1′).

The correcting part 7 corrects the pixel data D11 on the basis of the equation (3′). For this purpose, the pixel data D11 is read out from the memory 6. However, the pixel data D12 representing the driving voltage v12 is read out earlier than the pixel data D11 and then received by the multiplier 7a through an input portion In1 at an instant ta. Further, a coefficient data Dk12 representing the coefficient K12 is stored in the memory 6 and is received by the multiplier 7a through an input portion In2 at the instant ta.

The multiplier 7a multiplies the driving voltage v12 by the coefficient K12 and thus the second term (K12'v12) in the right side of the equation (3′) is calculated. This calculated (K12×v12) represents (Δv1′+Δv2) shown in FIG. 5. Since (Δv1′+Δv2) (=K12×v12) has been calculated, the correction voltage v11′ can be determined by subtracting (Δv1′+Δv2) (=K12×v12) from v11 as shown in the equation (3′). For this purpose, the calculated (Δv1′+Δv2) (=K12×v12) is outputted from an output portion Out1 of the multiplier 7a and then is received by the subtractor 7b through an input portion In3 at an instant tb. Further, an switch SW of the correcting part 7 is closed at the side of a terminal T1, the pixel data D11 representing the driving voltage v11 is read out from the memory 6 and then is received by the subtractor 7b through the switch SW and an input portion In4 at the instant tb. The subtractor 7b subtracts (K12×v12) from v11 and thus the equation (3′) is calculated. The pixel data D11′ representing the correction voltage v11′ is outputted from an output portion Out2 and then stored in the memory 6.

In this way, the pixel data D11 representing the driving voltage v11 is corrected to the pixel data D11′ representing the correction voltage v11′.

Further, the correcting part 7 corrects the pixel data D12 on the basis of the equation (1′). For this purpose, the pixel data D12 is read out from the memory 6. However, the pixel data D13 representing the driving voltage v13 is read out earlier than the pixel data D12 and then received by the multiplier 7a through the input portion In1 at an instant td. Further, a coefficient data Dk13 representing the co-efficient K13 is stored in the memory 6 and is received by the multiplier 7a through the input portion In2 at the instant td.

The multiplier 7a multiplies the driving voltage v13 by the coefficient K13 and thus the second term (K13×v13) in the right side of the equation (1′) is calculated. This (K13×v13) represents the amount of deviation in voltage Δv3 shown in FIG. 5. Since Δv3 (=K13×v13) has been calculated, the correction voltage v12′ can be determined by subtracting Δv3 (=K13×v13) from v12 as shown in the equation (1′). For this purpose, the calculated Δv3 (=K13×v13) is outputted from the output portion Out1 of the multiplier 7a and then is received by the subtractor 7b through the input portion In3 at an instant te. Further, the pixel data D12 representing the driving voltage v12 is read out from the memory 6 and then is received by the subtractor 7b through the switch SW and the input portion In4 at the instant te. The subtractor 7b subtracts (K13×v13) from v12 and thus the equation (1′) is calculated. The pixel data D12′ representing the correction voltage v12′ is outputted from the output portion Out2 and then stored in the memory 6.

In this way, the pixel data D11 and D12 are corrected to the pixel data D11′ and D12′, respectively. The pixel data D13 representing the driving voltage v13 is not corrected since the pixel data D13 need not be corrected. Therefore, the pixel data D11′, D12′ and D13 having been stored in the memory 6 are read out and then supplied to the source driver 5, so that the correction voltages v11′ and v12′ are supplied to the source lines L11 and L12, respectively, and the driving voltage v13 is supplied to the source line L13. The correction voltage v11′ supplied to the source line L11 is affected by the crosstalks CT1 and CT2 and finally deviates from the v11′ to the driving voltage v11 (see FIG. 5). Further, the correction voltage v12′ supplied to the source line L12 is affected by the crosstalk CT3 and finally deviates from the v12′ to the driving voltage v12 (see FIG. 5). The driving voltage v13 supplied to the source line L13 dose not deviate and thus remains the driving voltage v13. Therefore, the voltages V11(t), V12(t), and V13(t) on the source lines L11, L12, and L13 finally reach the desired driving voltages v11, v12, and v13, respectively, and thus the degradation of image quality is prevented.

Similarly the correcting part 7 corrects the pixel data D22 having been stored in the memory 6 to a pixel data D22′, the pixel data D22 representing the driving voltage v22 and the pixel data D22′ representing the correction voltage v22′. The correction voltage v22′ can be calculated by substituting the equation (7) into the equation (6). This calculation equation is represented by an equation (6′) below.

v22′=v22−(K23×v23) (6′)

Further, the correcting part 7 corrects the pixel data D21 having been stored in the memory 6 to a pixel data D21′, the pixel data D21 representing the driving voltage v21 and the pixel data D21′ representing the correction voltage v21′ (see equation (8)). Since the second term Δv4′ in the right side of the equation (8) is represented by the equation (9) and the third term Δv5 is represented by a sum of the equations (10) and (11), the correction voltage v21′ can be determined by calculating the equations (9), (10) and (11) and then substituting the calculation results in the equation (8). The correction voltage v21′ may be determined in this way, but can be more easily calculated without calculating the equations (9), (10) and (11). In order to calculate the correction voltage v21′ more easily, we try to substitute the equations (9), (10) and (11) in the equation (8).

v21′=v21−(Δv4′+Δv5) (8)

=v21−(Δv4′+Δv5′+Δv5″)

=v21−[(K22×(v22−Δv6)+K22×Δv6+K21×v13]=v21−(K21×v13+K22×v22)(8′)

The correction voltage v21′ is simply represented by the equation (8′). This (K21×v13) is equal to Δv5″ and this (K22×v22) is equal to (Δv4′+Δv5′). Therefore, the correction voltage v21′ can be determined by calculating (K21×v13) and (K22×v22) and then substituting the calculated (K21×v13) and (K22×v22) in the equation (8′) without calculating the equations (9), (10) and (11).

In order to correct the pixel data D21 and D22 using the above equations (8′) and (6′), respectively, the correcting part 7 operates as follows.

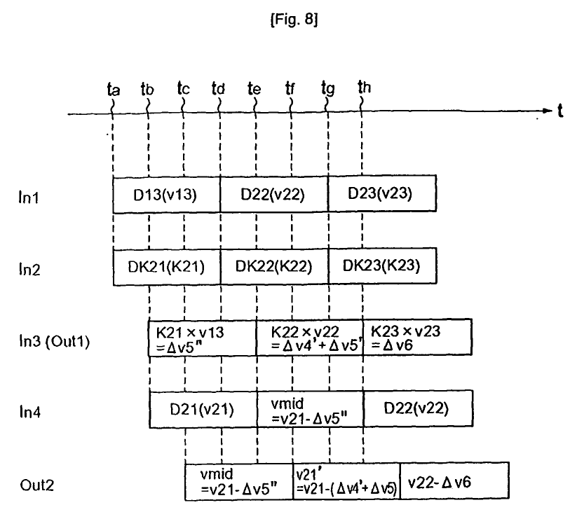

FIG. 8 illustrates one example of ways in which the correcting part 7 corrects the pixel data D21 and D22 on the basis of the above equations (8′) and (6′).

The correcting part 7 corrects the pixel data D21 on the basis of the equation (8′). In order to determine (K21×v13) and (K22×v22) of the equation (8′), the pixel data D13 representing the driving voltage v13 is read out from the memory 6 and then received by the multiplier 7a through the input portion In1 at the instant ta. Further, a coefficient data Dk21 representing the coefficient K21 is stored in the memory 6 and is received by the multiplier 7a through the input portion In2 at the instant ta.

The multiplier 7a multiplies the driving voltage v13 by the coefficient K21 and thus the (K21×v13) is calculated. This (K21×v13) represents Δv5″ shown in FIG. 6. The Δv5′ (=K21×v13) is outputted from the output portion Out1 of the multiplier 7a and then is received by the subtractor 7b through the input portion In3 at the instant tb. Further, the switch SW of the correcting part 7 is closed at the side of the terminal T1, the pixel data D21 representing the driving voltage v21 is read out from the memory 6 and then is received by the subtractor 7b through the switch SW and the input portion In4 at the instant tb. The subtractor 7b subtracts Δv5″ (=K21×v13) from v21 and thus the mid-correction voltage vmid represented by the equation (12) below is calculated.

vmid=v21−Δv5″=v21−K21×v13 (see the equation (11)) (12)

The mid-correction voltage vmid is not equal to the correction voltage v21′ and is greater than the correction voltage v21′ by (Δv4′+Δv5′). Therefore, in order to determine the correction voltage v21′, it is required to calculate (Δv4′+Δv5′) and then subtract (Δv4′+Δv5′) from the mid-correction voltage vmid. For this reason, (Δv4′+Δv5′) is calculated. Since the (Δv4′+Δv5′) is equal to (K22×v22), (Δv4′+Δv5′) is determined by calculating (K22×v22). For this purpose, at the instant td, the pixel data D22 representing the driving voltage v22 is received by the multiplier 7a through the input portion In1 and the coefficient data Dk22 representing the coefficient K22 is received by the multiplier 7a through the input portion In2.

The multiplier 7a multiplies the driving voltage v22 by the coefficient K22 and thus the (K22×v22) is determined. This (K22×v22) represents (Δv4′+Δv5′) (see FIG. 6). The calculated (Δv4′+Δv5′) (=K22×v22) is outputted from the output portion Out1 of the multiplier 7a and then is received by the subtractor 7b through the input portion In3 at an instant te. It is again noted that the correction voltage v21′ is determined by subtracting the (Δv4′+Δv5′) (=K22×v22) from the mid-correction voltage vmid. For this purpose, the switch SW is closed at the side of the terminal T2, and the mid-correction voltage vmid outputted from the output portion Out2 is received by the subtractor 7b through the switch SW and the input portion In4 at the instant te. The subtractor 7b subtracts (Δv4′+Δv5′) (=K22×v22) from the mid-correction voltage vmid and thus the correction voltage v21′ is calculated as shown in an equation below.

v21′=vmid−(Δv4′+Δv5′)=(v21−Δv5″)−(Δv4′+Δv5′)(see the equation (12))

=v21−(Δv5″+Δv4′+Δv5′)

=v21−(Δv4′+Δv5) (8′)

It is understood that the equation (8′) is equal to the equation (8).

The pixel data D21′ representing the correction voltage v21′ is outputted from the output portion Out2 at an instant tf and stored in the memory 6.

In this way, the pixel data D21 representing the driving voltage v21 is corrected to the pixel data D21′ representing the correction voltage v21′.

Further, the correcting part 7 corrects the pixel data D22 on the basis of the equation (6′). For this purpose, the pixel data D23 representing the driving voltage v23 is read out from the memory 6 and is received by the multiplier 7a through the input portion In1 at an instant tg. Further, a coefficient data Dk23 representing the co-efficient K23 is stored in the memory 6 and is received by the multiplier 7a through the input portion In2 at the instant tg.

The multiplier 7a multiplies the driving voltage v23 by the coefficient K23 and thus the second term (K23×v23) in the right side of the equation (6′) is calculated. This (K23×v23) represents the amount of deviation in voltage Δv6 shown in FIG. 6. Since Δv6 (=K23×v23) has been calculated, the correction voltage v22′ can be determined by subtracting Δv6 (=K23×v23) from v23 as shown in the equation (6′). For this purpose, the calculated Δv6 (=K23×v23) is outputted from the output portion Out1 of the multiplier 7a and then is received by the subtractor 7b through the input portion In3 at an instant th. Further, the pixel data D22 representing the driving voltage v22 is read out from the memory 6 and then is received by the subtractor 7b through the switch SW and the input portion In4 at the instant th. The subtractor 7b subtracts Δv6 (=K23×v23) from v22 and thus the equation (6′) is calculated. The pixel data D22′ representing the correction voltage v22′ is outputted from the output portion Out2 and then stored in the memory 6.

In this way, the pixel data D22 representing the driving voltage v22 is corrected to the pixel data D22′ representing the correction voltage v22′.

As described above, the pixel data D21 and D22 are corrected to the pixel data D21′ and D22′, respectively. The pixel data D23 representing the driving voltage v23 is not corrected since the pixel data D23 need not be corrected. Therefore, the pixel data D21′, D22′ and D23 having been stored in the memory 6 are read out and then supplied to the source driver 5, so that the correction voltages v21′ and v22′ are supplied to the source lines L21 and L22, respectively, and the driving voltage v23 is supplied to the source line L23. The correction voltage v21′ supplied to the source line L21 is affected by the crosstalks CT4, CT5 and CT7 and finally deviates from the v2′ to the driving voltage v21 (see FIG. 6). Further, the correction voltage v22′ supplied to the source line L22 is affected by the crosstalk CT6 and finally deviates from the v22′ to the driving-voltage v22. The driving voltage v23 supplied to the source line L23 dose not deviate and thus remains the driving voltage v23. Therefore, the voltages V21(t), V22(t), and V23(t) on the source lines L21, L22, and L23 finally reach the desired driving voltages v21, v22, and v23, respectively, and thus the degradation of image quality is prevented.

The memory 6 and the correcting part 7 shown in FIG. 1 is provided on the printed circuit board 2, but need not always be provided on the printed circuit board 2.

It can be generally considered that the parasitic capacitances C12 to C23 are substantially equal to each other and the liquid crystal capacitances Ca to Ce are substantially equal to each other. That is to say, it can be generally considered that the above coefficients K12, K13, K21, K22, and K23 are substantially equal to each other. It is therefore noted that even if the same coefficient data is always inputted into the input portion In2 of the multiplier 7a independently of the pixel data inputted into the input portion In1 of the multiplier 7a, the correction voltages can be determined with sufficient accuracy.

The correcting part 7 is not limited the structure shown in FIG. 4 and may be varied.

FIG. 9 is a variation of the correcting part 7.

It is noted that the correcting part 7 shown in FIG. 4 comprises one multiplier 7a, but the correcting part 7 shown in FIG. 9 comprises two multipliers 7c and 7d each having the same structure as the multiplier 7a shown in FIG. 4. The correcting part 7 shown in FIG. 9 further comprises a subtractor 7e. The subtractor 7e receives the pixel data rep-resenting the voltage through an input In4. The subtractor 7e receives multiplication results outputted from the multipliers 7c and 7d through input portions In3 and In7, respectively. The subtractor 7e subtracts the multiplication results obtained by the multipliers 7c and 7d from the voltage received through the input portion In4 to calculate the correction voltage.

The correcting part 7 shown in FIG. 9 comprises two multipliers 7c and 7d and thus has a larger occupying area than that of the correcting part 7 shown in FIG. 4, but may save the operation time and thus save the time for calculating the correction voltage. For example, the correcting part 7 shown in FIG. 4 is required to calculate (K22×v22) (=Δv4′+Δv5′) after calculating (K21×v13) (=Δv5″) and thus can not perform these calculations simultaneously (see FIG. 8). In contrast, the correcting part 7 shown in FIG. 9 comprises two multipliers 7c and 7d and thus can perform the calculations of Δv5″ and (Δv4′+Δv5′) simultaneously, so that the time for calculating the correction voltages is saved.

The correcting part 7 determines the amount of correction by performing the multiplication operation in which the voltage is multiplied by the coefficient, but the amount of correction may be determined in different manner from the multiplication operation.

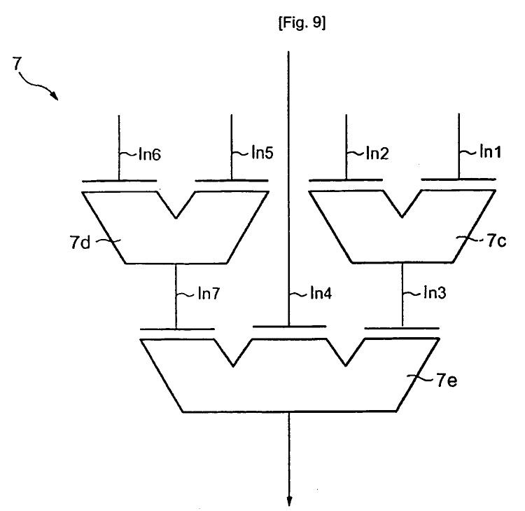

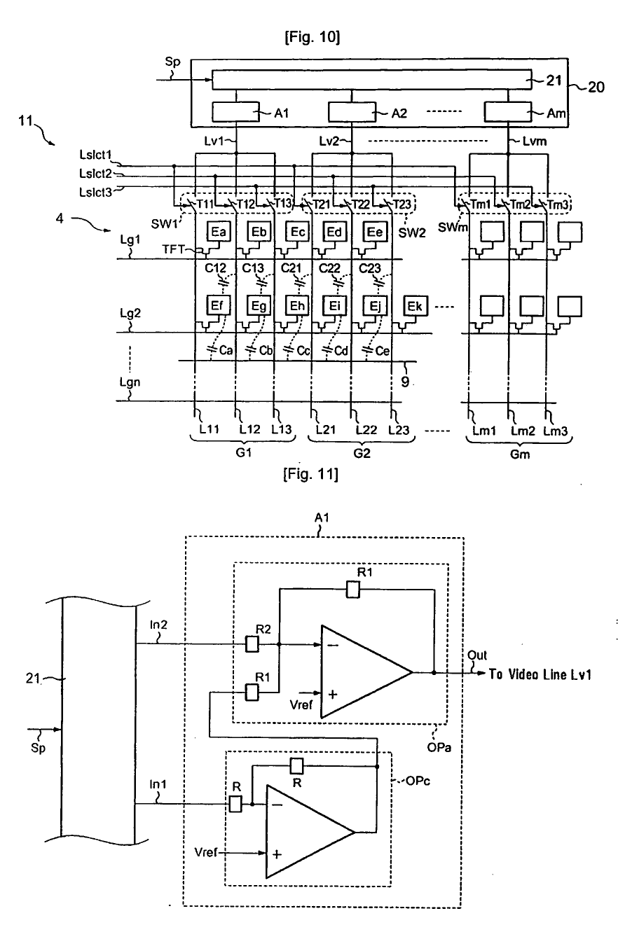

FIG. 10 shows an image display device 11 of a second embodiment according to the present invention.

Like the image display device 1 shown in FIG. 1, the image display device 11 comprises an electronic circuit part 4, three selecting lines Lslct1, Lslct2, Lslct3, and m video lines Lv1, Lv2, . . . , Lvm. The image display device 11 further comprises a source driver 20 having a different structure from the source driver 5 of the image display device 1 shown in FIG. 1. The source driver 20 comprises a DA conversion part 21 and m correcting parts A1, A2, . . . , Am corresponding to the m video lines Lv1, Lv2, . . . , Lvm. Each of the correcting part A1, A2, . . . , Am corrects a respective one of voltages outputted from the DA conversion part 21 and outputs a respective one of the correction voltages into a respective one of the video lines Lv1, Lv2, . . . , Lvm. The image display device 11 supplies each of the vide lines Lv1, Lv2, . . . , Lvm with a respective one of the correction voltages and thus prevents or reduces the image degradation caused through crosstalk. Assuming that the image display device 11 dose not comprise the correcting parts A1, A2, . . . , Am, the voltage on the source line varies as explained with respect to FIG. 3 and thus deviates from the desired voltage, so that the image is degraded. However, since the image display device 11 comprises the correcting parts A1, A2, . . . , Am, the device 11 can supply the correction voltage with the source line as in the case of the image display device 1 shown in FIG. 1, so that the image degradation is prevented or reduced. It is described below how the source driver 20 comprising the correcting parts A1, A2, . . . , Am supplies each of the video lines Lv1, Lv2, . . . , Lvm with a respective one of the correction voltages.

FIG. 11 is a circuit diagram showing the correcting part A1.

The correcting part A1 comprises input portions In1 and In2. The correcting part A1 corrects a voltage received through the input portion In1 using a voltage received through the input portion In2. By such operation of the correcting part A1, the source driver 20 can output the correction voltages v11′ and v12′ and the driving voltage v13 into the video line Lv1 as in the case of the source driver 5 shown in FIG. 1. In order that the source driver 20 may output such correction voltages v11′ and v12′ and driving voltage v13, the correcting part A1 receives the voltages as follows.

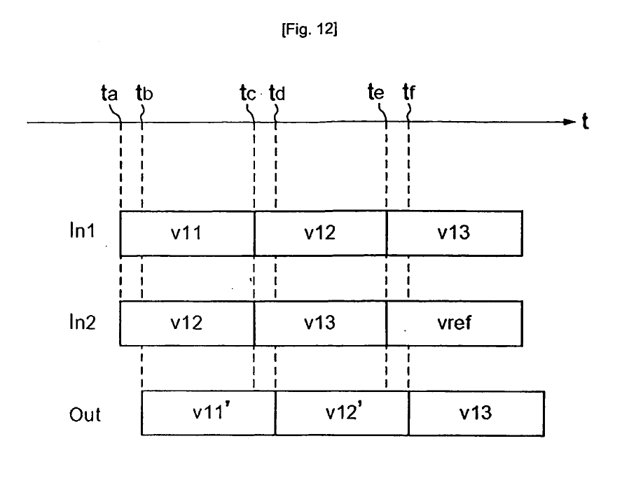

FIG. 12 shows voltages inputted into the input portions In1 and In2 of the correcting part A1 and a voltage outputted from an output portion Out of the correcting part A1.

If the correcting part A1 outputs the correction voltage v11′, the voltage V11(t) on the source line L11 can finally become the desired driving voltage v11. Since the correction voltage v11′ is represented by the equation (3′), it is understood that the correction voltage v I′ is obtained by subtracting (K12×v12) from the driving voltage v11. The (K12×v12) is obtained by multiplying the driving voltage v12 by the co-efficient K12. In order to obtain such correction voltage v11′, each of the driving voltages v11 and v12 is supplied from the source driver 21 to a respective one of the input portions In1 and In2 at an instant ta (see FIG. 12).

A sign of the driving voltage v11 inputted into the input portion In1 is inverted with a sign converter OPc, so that the sing converter OPc outputs a voltage—v11. Therefore, an adder OPa receives the voltages—v11 and v12 and outputs the correction voltage v11′ represented by an equation below at an instant tb.

v11′=v11−((R1/R2)×v12) (13)

In order for the correction voltage v11′ determined by the equation (13) to substantially become equal to the correction voltage v11′ determined by the equation (3′), the (R1/R2) of the equation (13) is required to be substantially equal to the coefficient K12 of the equation (3′). Therefore, values of resistances R1 and R2 are selected in such a way that R1/R2 is substantially equal to the coefficient K12. As a result, the desired correction voltage v11′ is outputted from the output portion Out.

After the correcting part A1 outputs the correction voltage v11′ for use on the source line L11, the correcting part A1 must output the correction voltage v12′ for use on the source line L12. Since the correction voltage v12′ is represented by the equation (1′), it is understood that the correction voltage v12′ is obtained by subtracting (K13×v13) from the driving voltage v12. The (K13×v13) is obtained by multiplying the driving voltage v13 by the coefficient K13. In order to obtain such correction voltage v12′, the driving voltage v12 is supplied from the source driver 21 to the input portion In1 and the driving voltage v13 is supplied from the source driver 21 to the input portion In2 at an instant tc.

A sign of the driving voltage v12 inputted into the input portion In1 is inverted with the sign converter OPc, so that the sing converter OPc outputs a voltage—v12. Therefore, the adder OPa receives the voltages—v12 and v13 and outputs the correction voltage v12′ represented by an equation below at an instant td.

v12′=v12−((R1/R2)×v13) (14)

In order for the correction voltage v12′ determined by the equation (14) to substantially become equal to the correction voltage v12′ determined by the equation (1′), the (R1/R2) of the equation (14) is required to be substantially equal to the coefficient K13 of the equation (1′). It is described that, in the explanation of the equation (13), R1/R2 is substantially equal to the coefficient K12, but it is noted that the coefficient K12 is substantially equal to the coefficient K13 and thus R1/R2 is substantially equal to the coefficient K13 also. Therefore, the desired correction voltage v12′ is outputted from the output portion Out.

After the correcting part A1 outputs the correction voltage v12′ for use on the source line L12, the correcting part A1 must output the driving voltage v13 for use on the source line L13. Since the driving voltage v13 need not be corrected, the correcting part A1 is required to output the driving voltage v13 itself. For this purpose, at an instant te, the source driver 21 supplies the input portion In1 with the driving voltage v13 and supplies the input portion In2 with a reference voltage vref. By this, the driving voltage v13 itself is outputted from the output portion Out.

In this way, the correcting part A1 sequentially outputs the correction voltages v11′ and v12′ and the driving voltage v13. Since the voltages v11′, v12′ and v13 are supplied to the source lines L11, L12, and L13, respectively, the voltage on the source line L11 finally becomes the desired driving voltage v11, the voltage on the source line L12 finally becomes the desired driving voltage v12, and the voltage on the source line L13 finally becomes the desired driving voltage v13. As a result, the degradation of image is prevented or reduced.

Next, an operation of the correcting part A2 is described below.

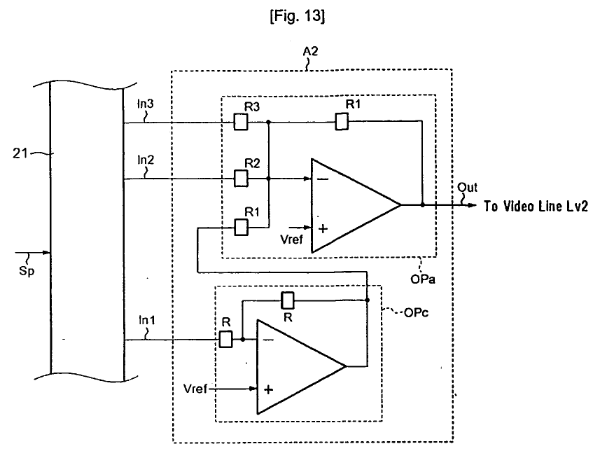

FIG. 13 is a circuit diagram showing the correcting part A2.

The correcting part A2 is the same structure as the correcting part A1 shown in FIG. 11 except that the correcting part A2 comprises an input portion In3 in addition to the input portions In1 and In2 and further comprises a resistance R3. The correcting part A2 corrects a voltage received through the input portion In1 using voltages received through the input portions In2 and In3. By such operation of the correcting part A2, the source driver 20 can output the correction voltages v21′ and v22′ and the driving voltage v23 into the video line Lv2 as in the case of the source driver 5 shown in FIG. 1. In order that the source driver 20 may output such correction voltages v21′ and v22′ and driving voltage v23, the correcting part A2 receives the voltages as follows.

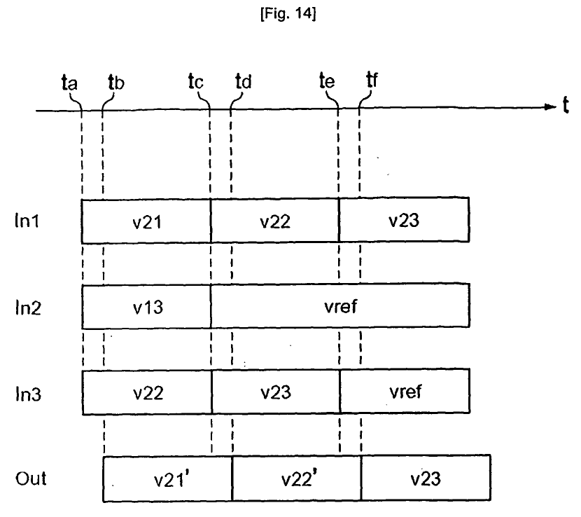

FIG. 14 shows voltages inputted into the input portions In1, In2 and In3 of the correcting part A2 and a voltage outputted from an output portion Out of the correcting part A2.

If the correcting part A2 outputs the correction voltage v21′, the voltage V21(t) on the source line L21 can finally become the desired driving voltage v21. Since the correction voltage v21′ is represented by the equation (8′), it is understood that the correction voltage v21′ is obtained by subtracting (K21×v13) and (K22×v22) from the driving voltage v21. The (K21×v13) is obtained by multiplying the driving voltage v13 by the coefficient K21 and the (K22×v22) is obtained by multiplying the driving voltage v22 by the coefficient K22. In order to obtain such correction voltage v21′, each of the driving voltages v21, v13 and v22 is supplied from the source driver 21 to a respective one of the input portions In1, In2 and In3 at an instant ta as shown in FIG. 14.

A sign of the driving voltage v21 inputted into the input portion In1 is inverted with a sign converter OPc, so that the sing converter OPc outputs a voltage—v21. Therefore, an adder OPa receives the voltages—v21, v13 and v22 and outputs the correction voltage v21′ represented by an equation below at an instant tb.

v21′=v21−[(R1/R2)×v13+(R1/R3)×v22] (15)

In order for the correction voltage v21′ determined by the equation (15) to substantially become equal to the correction voltage v21′ determined by the equation (8′), the (R1/R2) of the equation (15) is required to be substantially equal to the coefficient K21 of the equation (8′) and the (R1/R3) of the equation (15) is required to be substantially equal to the coefficient K22 of the equation (8′). Therefore, values of resistances R1, R2 and R3 is selected in such a way that R1/R2 is substantially equal to the coefficient K12 and R1/R3 is substantially equal to the coefficient K22. As a result, the desired correction voltage v21′ is outputted from the output portion Out.

After the correcting part A2 outputs the correction voltage v21′ for use on the source line L21, the correcting part A2 must output the correction voltage v22′ for use on the source line L22. Since the correction voltage v22′ is represented by the equation (6′), it is understood that the correction voltage v22′ is obtained by subtracting (K23×v23) from the driving voltage v22. The (K23×v23) is obtained by multiplying the driving voltage v23 by the coefficient K23. In order to obtain such correction voltage v22′, each of voltages v22, vref, and v23 is supplied from the source driver 21 to a respective one of the input portions In1, In2 and In3 at an instant tc.

A sign of the driving voltage v22 inputted into the input portion IN1 is inverted with the sign converter OPc, so that the sing converter OPc outputs a voltage—v22. Therefore, the adder OPa receives the voltages—v22, vref, and v23 and outputs the correction voltage v22′ represented by an equation below at an instant td.

v22′=v22−((R1/R3)×v23) (16)

In order for the correction voltage v22′ determined by the equation (16) to substantially become equal to the correction voltage v22′ determined by the equation (6′), the (R1/R3) of the equation (16) is required to be substantially equal to the coefficient K23 of the equation (6′). It is described that, in the explanation of the equation (15), R1/R3 is substantially equal to the coefficient K22, but it is noted that the coefficient K22 is substantially equal to the coefficient K23 and thus R1/R3 is substantially equal to the coefficient K23 also. Therefore, the desired correction voltage v22′ is outputted from the output portion Out.

After the correcting part A2 outputs the correction voltage v22′ for use on the source line L22, the correcting part A2 must output the driving voltage v23 for use on the source line L23. Since the driving voltage v23 need not be corrected, the correcting part A2 is required to output the driving voltage v23 itself. For this purpose, at an instant te, the source driver 21 supplies the input portion In1 with the driving voltage v23 and supplies the input portions In2 and In3 with reference voltages vref. By this, the driving voltage v23 itself is outputted from the output portion Out.

In this way, the correcting part A2 sequentially outputs the correction voltages v21′ and v22′ and the driving voltage v23. Since the voltages v21′, v22′ and v23 are supplied to the source lines L21, L22, and L23, respectively, the voltage on the source line L21 finally becomes the desired driving voltage v21, the voltage on the source line L22 finally becomes the desired driving voltage v22, and the voltage on the source line L23 finally becomes the desired driving voltage v23. As a result, the degradation of image is prevented or reduced. The other correcting parts A3 to Am can be explained similarly to the correcting part A2.

The correcting parts A1 and A2 shown in FIGS. 11 and 13 comprise resistances, but may comprise capacitances instead of resistances.

As described above, the first and second embodiments determine the correction voltage v11′, not only considering that the voltage V11(t) on the source line L11 deviates by the amount of deviation in voltage Δv1′ through the crosstalk CT1 but also considering that the voltage V11(t) deviates by the amount of deviation Δv2 through the crosstalk CT2 (see FIG. 5). However, the amount of deviation in voltage Δv2 is smaller enough than the amount of deviation in voltage Δv1′(for example, Δv2 is one several tenths of Δv1′), so that even if the correction voltage v11′ in which the amount of deviation in voltage Δv2 has been ignored is determined and used, this correction voltage v11′ is finally changed to a value being substantially equal to the desired driving voltage v11. Therefore, the correction voltage v11′ may be calculated using an equation (17) below in which the amount of deviation in voltage Δv2 has been ignored, instead of the equation (3) (=v11−(Δv1′+Δv2)).

v11′=v1−Δv1′ (17)

However, the equation (17) needs to use the driving voltage v13 in addition to the driving voltage v13 in order to determine the correction amount Δv1′ of the driving voltage v11 (see equations (4) and (2)). Therefore, for the purpose of easily determining the correction amount of the driving voltage v11, it is preferable that the correction voltage v11′ is calculated with the equation (3) (i.e. the equation (3′)), the equation (3′) making it possible to determine the correction amount without using the driving voltage v13.

The first and second embodiments determine the correction voltage v21′, not only considering that the voltage V21(t) on the source line L21 deviates by the amount of deviation in voltage Δv4′ through the crosstalk CT4 and deviates by the amount of deviation in voltage Δv5″ through the crosstalk CT7 but also considering that the voltage V21(t) deviates by the amount of deviation Δv5′ through the crosstalk CT5. However, the amount of deviation in voltage Δv5′ is smaller enough than the amounts of deviation in voltage Δv4′ and Δv5″ (for example, Δv5′ is one several tenths of Δv4′ and is one several tenths of Δv5″), so that even if the correction voltage v21′ in which the amount of deviation in voltage Δv5′ has been ignored is determined and used, this correction voltage v21′ is finally changed to a value being substantially equal to the desired driving voltage v21. Therefore, the correction voltage v21′ may be calculated using an equation (18) below in which the amount of deviation in voltage Δv5′ has been ignored, instead of the equation (8) (=v21−(Δv4′+Δv5)=v21−(Δv4′+Δv5′+Δv5″)).

v21′=v21−(Δv4′+Δv5″) (18)

However, the equation (18) needs to use the driving voltage v23 in addition to the driving voltages v13 and v22 in order to determine the correction amount (Δv4′+Δv5″) of the driving voltage v21 (see equations (9), (11) and (7)). Therefore, for the purpose of easily determining the correction amount of the driving voltage v21, it is preferable that the correction voltage v21′ is calculated with the equation (8) (i.e. the equation (8′)), the equation (8′) making it possible to determine the correction amount without using the driving voltage v23.

The correcting parts A1 to Am shown in FIG. 10 are provided in the source driver 20, but need not always be provided in the source driver 20.

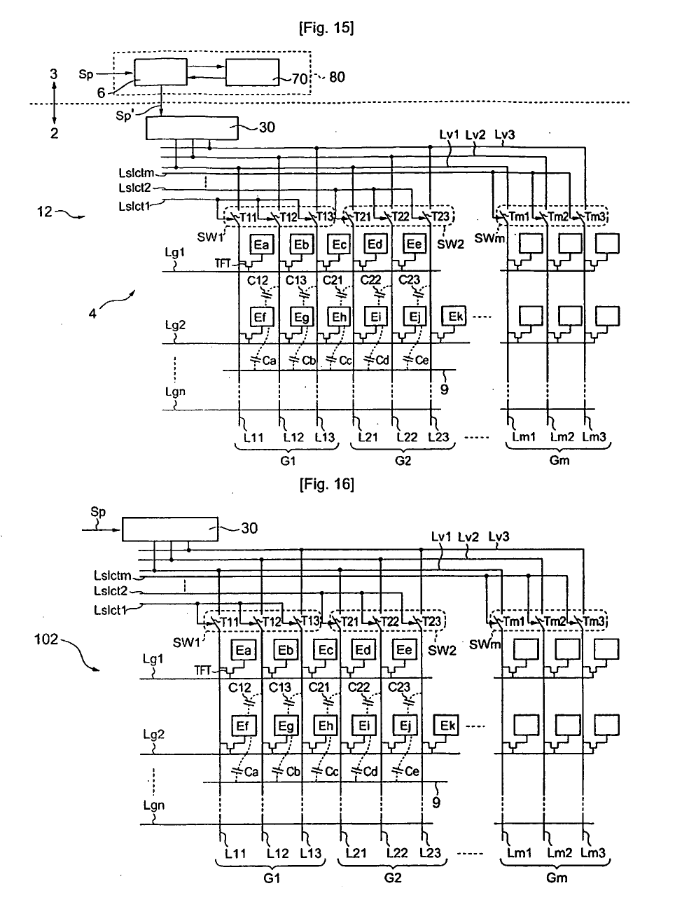

FIG. 15 shows an image display device 12 of the third embodiment according to the present invention.

In FIG. 15, parts of the image display device 12 at the sides of a glass substrate 2 and a printed circuit board 3 are schematically shown. At the side of the glass substrate 2, provided are an electronic circuit part 4, m selecting lines Lslct1, Lslct1, . . . , Lslctm, three video lines Lv1, Lv2, and Lv3, a source driver 30 and others. The electronic circuit part 4 shown in FIG. 15 has the same structure as the electronic circuit part 4 of the image display device 1 shown in FIG. 1. At the side of the printed circuit board 3, provided are a signal processing part 8 and others.

On the glass substrate 2, three video lines Lv1, Lv2, and Lv3 are formed. The video line Lv1 is provided to supply each of the source lines L11, L21, . . . , Lm1 belonging to a respective one of the source line groups G1, G2, . . . , Gm with a voltage. The video line Lv2 is provided to supply each of the source lines L12, L22, . . . , Lm2 belonging to a respective one of the source line groups G1, G2, . . . , Gm with a voltage. The video line Lv3 is provided to supply each of the source lines L13, L23, . . . , Lm3 belonging to a respective one of the source line groups G1, G2, . . . , Gm with a voltage. The voltages from the video lines Lv1, Lv2, and Lv3 are supplied to each of the source line groups G1, G2, . . . , and Gm via a respective one of the switch groups SW1, SW2, . . . , and SWm each consisting of three transistors. The transistors T11, T12, and T13 belonging to the switch group SW1 are turned on and off, depending on voltages supplied from the selecting line Lslct1. Similarly, the transistors T21, T22, and T23 belonging to the switch group SW2 are turned on and off depending on voltages supplied from the selecting line Lslct2, and the transistors Tm1, Tm2, and Tm3 belonging to the switch group SWm are turned on and off depending on voltages supplied from the selecting line Lslctm.

The signal processing part 80 corrects the received image signal Sp in order to prevent or reduce the image degradation caused through the crosstalk between the adjacent source lines. The corrected image signal Sp′ is outputted into the source driver 30. The source driver 30 supplies each of the video lines Lv1, Lv2, and Lv3 with voltage on the basis of the corrected image signal Sp′. Therefore, the image display device 12 shown in FIG. 15 can prevent or reduce the image degradation caused through the crosstalk between the adjacent source lines. In contrast, assuming that the image display device 12 dose not correct the image signal Sp and thus supplies the image signal Sp itself to the source driver 30, the image degradation would occur through the crosstalk between the adjacent source lines. In order to consider the reason for an occurrence of the image degradation, we discuss below an operation of an image display device which dose not correct the image signal Sp.

FIG. 16 is a schematic diagram showing the image display device 102 which dose not correct the image signal Sp.

The image display device 102 shown in FIG. 16 is the same as the image display device 12 shown in FIG. 15, except that the image signal Sp is not corrected and thus the image signal Sp itself is supplied to the source driver 30.

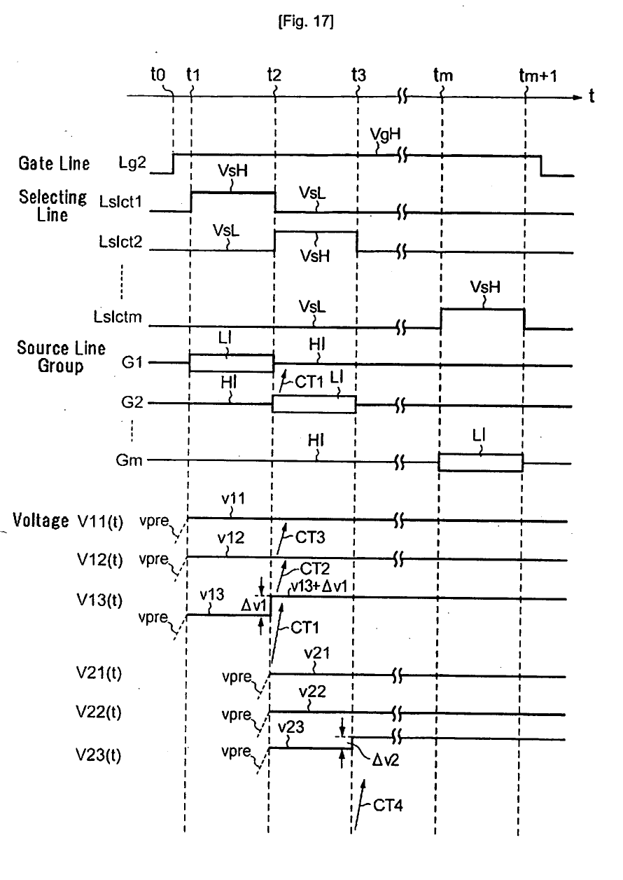

FIG. 17 shows a timing chart of the image display device 102 shown in FIG. 16.

FIG. 17 shows a timing chat while a gate line Lg2 of n gate lines of the image display device 102 is supplied with a high level voltage VgH. The m selecting lines Lslct1 to Lslctm are supplied with a high level voltage VsH and a low level voltage VsL while the gate line Lg2 is supplied with the voltage VgH. The selecting line Lslct1 is supplied with the high level voltage VsH during a period from an instant t1 to an instant t2, the selecting line Lslct2 is supplied with the high level voltage VsH during a period from the instant t2 to an instant t3, and the selecting line Lslctm is supplied with the high level voltage VsH during a period from the instant tm to an instant tm+1. In this way, the selecting lines Lslct1 to Lslctm are sequentially supplied with the high level voltage VsH. Three transistors of each of the switch groups SW1 to SWm become on-state while the selecting line corresponding to this three transistors is supplied with the voltage VsH, and become off-state while the selecting line corresponding to this three transistors is supplied with the voltage VsL. Since the selecting lines Lslct1 to Lslctm are sequentially supplied with the high level voltage VsH, the switch groups SW1 to SWm sequentially become on-state. Therefore, when the voltage on the selecting line Lslct1 is the high level voltage VsH (the instants t1 to t2), the source lines belonging to the source line group G1 are in the low-impedance state L1, but the source lines belonging to the remaining source line groups G2 to Gm are in the high-impedance state HI. When the voltage on the selecting line Lslct2 is the high level voltage VsH (the instants t2 to t3), the source lines belonging to the source line group G2 are in the low-impedance state L1, but the source lines belonging to the remaining source line groups are in the high-impedance state HI. Further, when the voltage on the selecting line Lslctm is the high level voltage VsH (the instants tm to tm+1), the source lines belonging to the source line group Gm are in the low-impedance state L1, but the source lines belonging to the remaining source line groups are in the high-impedance state HI. The image display device 102 shown in FIG. 16 supplies any source line groups G1 to Gm with the voltages in a similar manner, so it is explained below, as an example, how two source line groups G1 and G2 are supplied with the voltages.

The source driver 30 simultaneously supplies the source lines with pre-charge voltages vpre in advance. The pre-charge voltage vpre is zero voltage in this example, but may take any value. After the source lines are supplied with the pre-charge voltages vpre (zero voltage), the source line group G1 first becomes the low-impedance state L1 in which the group G1 is connected to the video lines Lv1, Lv2, and Lv3 (the instants t1 to t2). That is to say, three source lines L11, L12, and L13 belonging to the source line group G1 are connected to the video lines Lv1, Lv2 and Lv3, respectively. Further, the source driver 30 receives pixel data D11 representing the driving voltage v11, pixel data D12 representing the driving voltage v12, and pixel data D13 representing the driving voltage v13, converts each of the received pixel data D11, D12 and D13 into a respective one of the driving voltages v11, v12, and V13 (DA conversion), and then outputs each of the driving voltage v11, v12, v13 into a respective one of the video lines Lv1, Lv2 and Lv3. The driving voltages v11, v12 and v13 are voltages to be supplied to the pixel electrodes Ef, Eg and Eh through the source lines L11, L12 and L13, respectively. Since the source lines belonging to the source line group G1 are in the low-impedance state L1 in a period from the instant t1 to the instant t2, the driving voltages v11, v12 and v13 are supplied to the source lines L11, L12 and L13, respectively. Therefore, a voltage V11(t) on the source line L11 changes from the pre-charge voltage vpre to the driving voltage v11 at the instant t1, a voltage V12(t) on the source line L12 changes from the pre-charge voltage vpre to the driving voltage v12 at the instant t1, and a voltage V13(t) on the source line L13 changes from the pre-charge voltage vpre to the driving voltage v13 at the instant t1.

Next, the source line group G2 becomes the low-impedance state L1 in which the group G2 is connected to the video lines Lv1, Lv2, and Lv3 (the instants t2 to t3). On the other hand, the source driver 30 receives pixel data D21 representing the driving voltage v21, pixel data D22 representing the driving voltage v22, and pixel data D23 representing the driving voltage v23, converts each of the received pixel data D21, D22 and D23 into a respective one of the driving voltages v21, v22 and v23 (DA conversion), and then outputs each of the driving voltage v21, v22, v23 into a respective one of the video lines Lv1, Lv2 and Lv3. The driving voltage v21 is a voltage to be supplied to the pixel electrode through the source line L21. The driving voltage v22 is a voltage to be supplied to the pixel electrode through the source line L22. The driving voltage v23 is a voltage to be supplied to the pixel electrode through the source line L23. Since the source lines belonging to the source line group G2 are in the low-impedance state L1 in a period from the instant t2 to the instant t3, the driving voltages v21, v22 and v23 are supplied to the source lines L21, L22 and L23, respectively. Therefore, a voltage V21(t) on the source line L21 changes from the pre-charge voltage vpre to the driving voltage v21 at the instant t2, a voltage V21(t) on the source line L21 changes from the pre-charge voltage vpre to the driving voltage v21 at the instant t2, and a voltage V23(t) on the source line L23 changes from the pre-charge voltage vpre to the driving voltage v23 at the instant t2.

As described above, each source lines is supplied with the voltage. Hereinafter, we discuss the voltage V13(t) on the source line L13 belonging to the source line group G1 and the voltage V21(t) on the source line L21 belonging to the source line group G2.

The source driver 30 supplies the source line L13 with the driving voltage v13 through the video line Lv3 during the period from the instant t1 to the instant t2, so that the voltage V13(t) on the source line L13 becomes v13 (V13(t)=v13). Next, the source driver 30 outputs the driving voltage v21 into the video line Lv1 during the period from the instant t2 to the instant t3 in order to supply the source line L21 with the driving voltage v21. Since the source line L21 (the source line group G2) changes from the high-impedance state HI to the low-impedance state L1 at the instant t2, the driving voltage v21 is supplied to the source line L21 and thus the voltage V21(t) on the source line L21 becomes v12 (V21(t)=v21). It is required that the driving voltage v21 is not supplied to the source line L11 since the driving voltage v21 is the voltage for use on the source line L21. For this purpose, the source line L11 (the source line group G1) changes from the low-impedance state L1 to the high-impedance state HI at the instant t2. Therefore, the driving voltage v21 is prevented from being supplied to the source line L11. It is however noted that during the period from the instant t2 to the instant t3 the source line L21 (the source line group G2) is in the low-impedance state L1, but the source line L13 (the source line group G1) is in the high-impedance state HI. This means that the source line L13 is electrically disconnected from the video line Lv3, and thus the supply of the voltage from the video line Lv3 to the source line L13 is being blocked. Therefore, the voltage V13(t) on the source line L13 varies through a crosstalk CT1 between the source lines L13 and L21. Since the voltage V21(t) on the source line L21 changes from the pre-charge voltage vpre (voltage zero) to the driving voltage v21 at the instant t2, the voltage V21(t) changes by an amount of change in voltage, i.e. v21 (=v21−vpre) at the instant t2. Therefore, the voltage V13(t) on the source line L13 deviates by an amount of deviation in voltage Δv1 at the instant t2, the amount Δv1 depending on the amount of change in voltage (i.e. v21) on the source line L21.

Therefore, the voltage V13(t) on the source line L13 is the desired driving voltage v13 at first, but is affected by the change of voltage on the source line L21 through the crosstalk CT1 and thus deviates from the voltage v13 to a voltage v13+Δv1. Since the voltage V13(t) on the source line L13 deviates by an amount of deviation in voltage Δv1 at the instant t2, the voltage V12(t) on the source line L12 is affected by the amount of deviation in voltage Δv1 through the crosstalk CT2 and thus deviates. However, in this case, the deviation of voltage V12(t) on the source line L12 is in a range from one several tenths of the amount of deviation in voltage Δv1 to one several hundredths of Δv1 and thus may be substantially ignored. Therefore, we ignore the deviation of voltage V12(t) on the source line L12 through the crosstalk CT2. Similarly, we ignore the deviation of voltage V11(t) on the source line L11 through the crosstalk CT3.

The above description is given to the deviation in voltage in the source line group G1, but the similar description can be given to the deviation in voltage in the source line group G2. The voltage V23(t) on the source line L23 deviates by an amount of deviation in voltage Δv2 through the crosstalk CT4 coming from the source line L31 belonging to the source line group G3. The remaining source line groups can be explained similarly to the source line group G1.

As described above, in the image display device 102, the voltage on the source line deviates through the crosstalk, so that the image is degraded. In contrast, the image display device 12 (see FIG. 15) of third embodiment makes use of such deviation in voltage on the source line as in the case of the image display devices 1 and 11 (see FIGS. 1 and 10) in order to prevent the image degradation. Specifically, the image display device 12 predicts an amount of deviation in voltage on the source line and then supplies the source line with a correction voltage, the correction voltage differing by the predicted amount of deviation in voltage from an original voltage expected to be supplied to the source line. The supply of the correction voltage to the source line makes it possible to prevent the image from degrading. It will be described below how to generate such correction voltage.

The image display device 12 shown in FIG. 15 comprises a memory 6 and a correcting part 70 in the signal processing part 80 in order to generate such correction voltage.

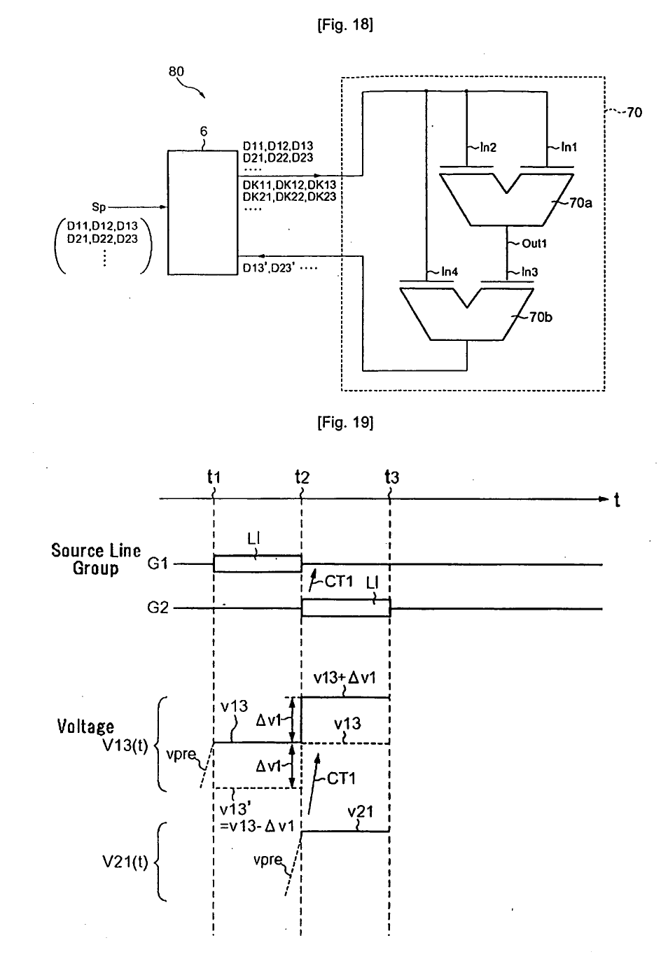

FIG. 18 shows one example of the signal processing part 80.

The signal processing part 80 comprises the memory 6 and the correcting part 70. The correcting part 70 has the same structure as the correcting part 7 shown in FIG. 4, except that the input portion In4 is connected to the memory 6 without using the switch SW. Like the correcting part 7 shown in FIG. 4, the correcting part 70 corrects the pixel data by an amount of correction, the amount of correction corresponding to the amount of deviation in voltage caused through the crosstalk. For correcting the pixel data, the correcting part 70 determines the amount of deviation in voltage caused through the crosstalk as follows.

FIG. 19 is illustration of determining the amount of deviation in voltage caused through the crosstalk.

FIG. 19 schematically illustrates waveforms of the voltages V13(t) and V21(t) on the source lines L13 and L21. At first, we discuss the voltage V13(t) on the source line L13. As explained with respect to FIG. 17, if the source line L13 is supplied with the driving voltage v13, the voltage V13(t) on the source line L13 deviates from the driving voltage v13 to the voltage v13+Δv1 through a crosstalk CT1 between the source lines L13 and L21. Therefore, if the source line L13 may be supplied with the correction voltage v13′ represented by an equation (19) below instead of the driving voltage v13, the voltage V13(t) on the source line L13 can finally become the desired driving voltage v13.

v13′=v13−Δv1 (19)

If the correction voltage v13′ is supplied to the source line L13, the voltage V13(t) on the source line L13 is first smaller than the desired driving voltage v13 by Δv1, but deviates through the crosstalk CT1 and thus finally reaches the desired driving voltage v13.

It is noted that the amount of deviation in voltage Δv1 is substantially determined on the basis of the amount of change in voltage (v21=v21−vpre) of the voltage V21(t) on the source line L21 at the instant t2, a parasitic capacitance C21 and a liquid crystal capacitance Cc (see FIG. 16). The parasitic capacitance C21 is formed between the source line L21 and the pixel electrode Eh, and the liquid crystal capacitance Cc is formed between the common electrode 9 and the pixel electrode Eh. The values of the parasitic capacitance C21 and the liquid crystal capacitance Cc both can be known from kinds of the liquid crystal material, source line material and others, and can be considered as substantially constant values. Therefore, the amount of deviation in voltage Δv1 can be calculated using an equation (20) below.

Δv1=K21×v21 (20)

Where, a coefficient K21 is a constant value substantially determined on the basis of the parasitic capacitance C21 and the liquid crystal capacitance Cc. Since the correction voltage v13′ can be calculated using the equations (19) and (20), the source line L13 can be supplied with the correction voltage v13′.

In order to determine such correction voltage, the image display device 12 shown in FIG. 15 comprises a multiplier 70a and a subtractor 70b in the correcting part 70. The multiplier 70a calculates an amount of deviation in voltage caused through crosstalk. The subtractor 70b corrects the image data using the amount of deviation in voltage calculated in the multiplier 70a. It is described below in detail how the correcting part 70 corrects the pixel data.

As shown in FIG. 18, the pixel data D11, D12, . . . of the image signal Sp are once written in the memory 6. The signal processing part 80 corrects the written pixel data with its correcting part 70 before the signal processing part 80 outputs the written pixel data into the source driver 20. The correcting part 70 corrects the pixel data for the purpose of supplying the correction voltages mentioned with respect to FIG. 19 to the source lines. For example, the correcting part 70 corrects the pixel data D13 having been stored in the memory 6 to a pixel data D13′, the pixel data D13 representing the driving voltage v13 and the pixel data D13′ representing the correction voltage v13′ (see equation (19)). The correction voltage v13′ can be calculated by substituting the equation (20) into the equation (19). This calculation equation is represented by an equation (17′) below.

v13′=v13−(K21×v21) (19′)

In order to correct the pixel data D13 using the above equation (19′), the correcting part 70 operates as follows.

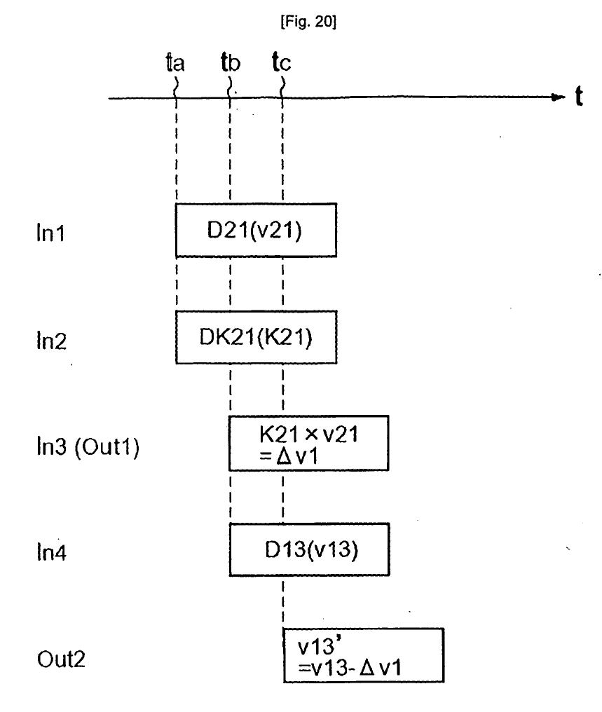

FIG. 20 is illustration of explaining how to correct the pixel data D13.

The correcting part 70 corrects the pixel data D13 on the basis of the equation (19′). For this purpose, the pixel data D21 representing the driving voltage v21 is read out from the memory 6 (see FIG. 18) and then is received by the multiplier 70a through an input portion In1 at an instant ta. Further, a coefficient data Dk21 representing the co-efficient K21 is stored in the memory 6 and is received by the multiplier 70a through an input portion In2 at the instant ta.

The multiplier 70a multiplies the driving voltage v21 by the coefficient K21 and thus the second term (K21×v21) in the right side of the equation (19′) is calculated. This (K21×v21) represents Δv1 shown in FIG. 19. Since Δv1 (=K21×v21) has been calculated, the correction voltage v13′ can be determined by subtracting Δv1 (=K21×v21) from v13 as shown in the equation (19′). For this purpose, the calculated Δv1 (=K21×v21) is outputted from an output portion Out1 of the multiplier 70a and then is received by the subtractor 70b through an input portion In3 at an instant tb. Further, the pixel data D13 representing the driving voltage v13 is read out from the memory 6 and then is received by the subtractor 70b through an input portion In4 at the instant tb. The subtractor 70b subtracts (K21×v21) from v13 and thus the equation (19′) is calculated. The pixel data D13′ representing the correction voltage v13′ is outputted from an output portion Out2 and then stored in the memory 6.

In this way, the pixel data D13 representing the driving voltage v13 is corrected to the pixel data D13′ representing the correction voltage v13′. The pixel data D11 rep-resenting the driving voltage v11 and the pixel data D12 representing the driving voltage v12 are not corrected since the pixel data D11 and D12 need not be corrected. Therefore, the pixel data D11, D12 and D13′ are supplied to the source driver 30, so that the driving voltages v11 and v12 are supplied to the source lines L11 and L12, respectively, and the correction voltage v13′ is supplied to the source line L13. The driving voltages v11 and v12 supplied to the source lines L11 and L12 do not substantially vary. The correction voltage v13′ (=v13−Δv1) supplied to the source line L13 is affected by the crosstalk CT1 and finally deviates from the v13′ to the driving voltage v13. Therefore, the voltages V11(t), V12(t), and V13(t) on the source lines L11, L12, and L13 finally reach the desired driving voltages v11, v12, and v13, respectively, and thus the degradation of image quality is prevented.

The source line groups G2 to Gm-1 are supplied with the voltages in the similar manner. It is noted that the voltages supplied to the source line group Gm need not be corrected since the source line group Gm is not affected by the deviation of voltage caused through the crosstalk.

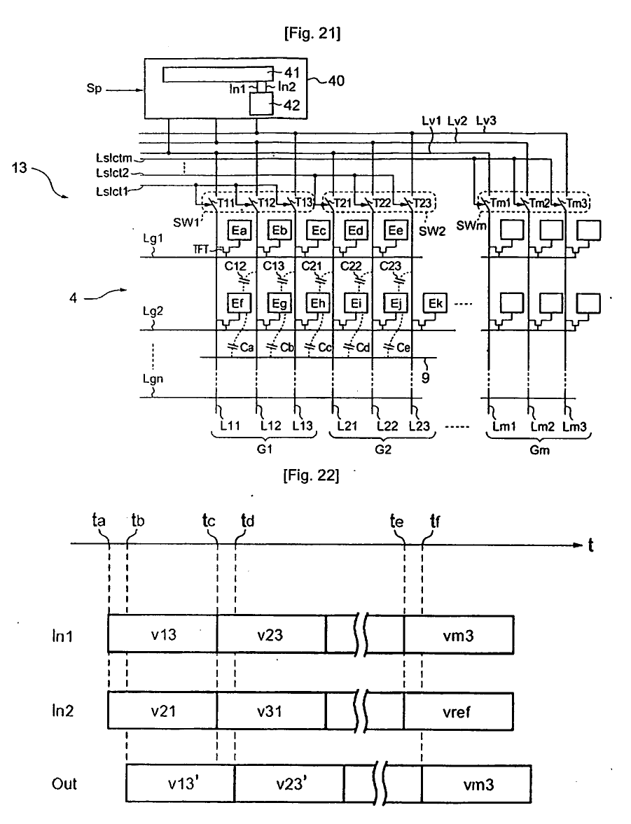

FIG. 21 shows an image display device 13 of the fourth embodiment according to the present invention.

Like the image display device 12 shown in FIG. 15, the image display device 13 comprises an electronic circuit part 4, m selecting lines Lslct1 to Lslctm, three video lines Lv1, Lv2, and Lv3. Further, the image display device 13 comprises a source driver 40 having different structure from the source driver 30 of the image display device 12 show in FIG. 15. The source driver 40 comprises a DA converter 41 and one correcting part 42 corresponding to the video line Lv3. The source driver 40 supplies the video lines Lv1 and Lv2 with the voltages outputted from the DA converter 41. However, the source driver 40 dose not supply the video line Lv3 with the voltage outputted from the DA converter 43 but supplies the video line Lv3 with the voltage outputted from the DA converter 43 and passed through the correcting part 42. The image display device 13 supplies the vide line Lv3 with the correction voltages and thus prevents or reduces the image degradation caused through crosstalk. Assuming that the image display device 13 dose not comprise the correcting part 42, the voltage on the source line varies as explained with respect to FIG. 17 and thus deviates from the desired voltage, so that the image is degraded. However, since the image display device 13 comprises the correcting part 42, the device 13 can supplies the correction voltage with the source line as in the case of the image display device 12 shown in FIG. 15, so that the image degradation is prevented or reduced. The correcting part 42 can have the same structure as the correcting part A1 shown in FIG. 11 for example. In the case that the correcting part 42 has the same structure as the correcting part A1 shown in FIG. 11, the correcting part 42 receives voltages as follows (see FIG. 22).

FIG. 22 shows voltages inputted into the input portions In1 and In2 of the correcting part 42 and a voltage outputted from an output portion Out of the correcting part 42.

If the correcting part 42 outputs the correction voltage v13′, the voltage V13(t) on the source line L13 can finally become the desired driving voltage v13. Since the correction voltage v13′ is represented by the equation (19′), it is understood that the correction voltage v13′ is obtained by subtracting (K21×v21) from the driving voltage v13. The (K21×v21) is obtained by multiplying the driving voltage v21 by the co-efficient K21. In order to obtain such correction voltage v13′, each of the driving voltages v13 and v21 is supplied to a respective one of the input portions In1 and In2 at an instant ta as shown in FIG. 22.

A sign of the driving voltage v13 inputted into the input portion In1 is inverted with a sign converter OPc, so that the sing converter OPc outputs a voltage—v13. Therefore, an adder OPa receives the voltages—v13 and v21 and outputs the correction voltage v13′ represented by an equation below at an instant tb.

v13′=v13−((R1/R2)×v21) (21)

In order for the correction voltage v13′ determined by the equation (21) to substantially become equal to the correction voltage v13′ determined by the equation (19′), the (R1/R2) of the equation (21) is required to be substantially equal to the co-efficient K21 of the equation (19′). Therefore, values of resistances R1 and R2 are selected in such a way that R1/R2 is substantially equal to the coefficient K21. As a result, the desired correction voltage v13′ is outputted from the output portion Out.

The correcting part 42 outputs the correction voltages v23′, v33′, . . . into the source lines L23, L33, . . . of the source line groups G2, G3, . . . in the similar way. However, since the source line Lm3 of the source line group Gm need not be supplied with the correction voltage, the correcting part 42 is required to supply the video line Lv3 with the driving voltage vm3 itself without correcting the driving voltage vm3. For this purpose, at an instant te, the input portion In1 is supplied with the driving voltage vm3 and the input portion In2 is supplied with the reference voltage vref. By this, the driving voltage vm3 itself is outputted from the output portion Out.

In this way, the correcting part 42 sequentially outputs the correction voltages v13′, v23′, . . . and the driving voltage vm3. Such voltages are supplied to the source lines. Therefore, the voltage on the source line finally becomes the desired voltage and thus image degradation is prevented or reduced.

In the third and forth embodiments, the amounts of deviation in voltage caused through the crosstalks CT2 and CT3 (see FIG. 17) are negligible, so that the source lines L11 and L12 are supplied with the voltages without the process of correction. However, if the amounts of deviation in voltage caused through the crosstalks CT2 and CT3 are not negligible, the correction voltages may be determined in consideration of the amounts of deviation in voltage caused through the crosstalks CT2 and CT3. Such correction voltages can be determined in the similar way as the correction voltages determined in the first and second embodiments.

In the first to fourth embodiments, the source line is supplied with the pre-charge voltage in advance, but may be not supplied with the pre-charge voltage. Even if the pre-charge voltage is not supplied, the image degradation can be prevented by correcting the driving voltage by an amount of deviation in voltage as described above.

Further, according to the present invention, a process performed with hardware in each of the above embodiments may be performed with software and a process performed with software in each of the above embodiments may be performed with hardware, provided that the correction voltage is supplied to the line.

The first to fourth embodiments refer to examples in which the correction voltage is generated using the pixel data, but the present invention may be applied to examples in which the correction voltage is generated using the other data than the pixel data.

1. A voltage supplying device comprising:
a first line;
a second line adjacent to said first line; and
a voltage generating means for generating a voltage supplied to said first line and
a voltage supplied to said first line,
wherein said voltage generating means receives a first data representing a first voltage for said first line and a second data representing a second voltage for said second line, and generates a correction voltage different from said first voltage using said received first and second data,
and wherein said voltage supplying device supplies said first line with said correction voltage.

2. A voltage supplying device as claimed in claim 1, wherein said voltage generating means comprises:
a first correction means for generating a correction data representing said correction voltage using said first and second data; and
a first converting means for converting said correction data into said correction voltage.

3. A voltage supplying device as claimed in claim 2, wherein said first correction means determines an amount of correction in data of said first data using said second data, and generates said correction data by correcting said first data using said amount of correction in data.

4. A voltage supplying device as claimed in claim 1, wherein said device comprises a third line adjacent to said first line, said third line existing opposite said second line,
and wherein said voltage generating means receives also a third data representing a third voltage for on said third line, and generates said correction voltage using said received first, second and third data.

5. A voltage supplying device as claimed in claim 4, wherein said voltage generating means comprises:
a first correction means for generating a correction data representing said correction voltage using said first and second data; and
a first converting means for converting said correction data into said correction voltage.

6. A voltage supplying device as claimed in claim 5, wherein said first correction means generates said correction data using said first, second and third data.

7. A voltage supplying device as claimed in claim 5, wherein said first correction means determines an amount of correction in data of said first data using said second and third data, and generates said correction data by correcting said first data using said amount of correction in data.

8. A voltage supplying device as claimed in claim 1, wherein said voltage generating means comprises:
a second converting means for converting said first data into said first voltage and converting said second data into said second voltage; and
a second correction means for generating said correction voltage using said first and second voltages.

9. A voltage supplying device as claimed in claim 8, wherein said second correction means generates said correction voltage by correcting said first voltage using said second voltage.

10. A voltage supplying device as claimed in claim 8, wherein said device comprises a third line adjacent to said first line, said third line existing opposite said second line,
wherein said voltage generating means receives a third data for said third line, wherein said second converting means converts said received third data into said third voltage,
and wherein said second correction means generates said correction voltage using said first, second and third voltages.

11. A voltage supplying device as claimed in claim 10, wherein said second correction means generates said correction voltage by correcting said first voltage using said second and third voltages.

12. An image display device comprising said voltage supplying device as claimed in any one of claims 1 to 11.
